(19) United States
(12) Patent Application Publication
(10) Pub. No.: US 2013/0103564 A1
(43) Pub. Date: Apr. 25, 2013

(54) INTERACTIVE CONTROL OF A WEBSITE-BASED TRADING PLATFORM FOR AUTOMATING THE ALLOCATION OF A USER'S INVESTMENT AMOUNT ON ONE OR MORE SIGNAL PROVIDERS

(71) Applicant: Leon YOHAI-GIOCHAIS, Attiki (GR)

(72) Inventor: Leon YOHAI-GIOCHAIS, Attiki (GR)

(21) Appl. No.: 13/644,033

(22) Filed: Oct. 3, 2012

Related U.S. Application Data
(60) Provisional application No. 61/550,552, filed on Oct. 24, 2011.
(60) Provisional application No. 61/563,377, filed on Nov. 23, 2011.
(60) Provisional application No. 61/569,490, filed on Dec. 12, 2011.
(60) Provisional application No. 61/584,438, filed on Jan. 9, 2012.
(60) Provisional application No. 61/617,302, filed on Mar. 29, 2012.

(51) Int. Cl. G06Q 40/04

(52) U.S. Cl. 705/37

(57) ABSTRACT

A method of providing an investment strategy with selected characteristics that are expected to provide acceptable profits within acceptable risks. A computer system performing the method receives a user's defined risk value, calculates a risk per provider value and calculates a worst case lots value in order to calculate a hypothetical profit target and a number of lots for each signal provider. Alternatively, the computer system calculates the available capital, calculates an NME value, calculates the number of lots for each signal provider and then calculates the number of lots for each signal provider and allows the user to manually modified the setting of weight control.

### CROSS-REFERENCE TO RELATED APPLICATIONS

The present application claims priority to and incorporates by reference the following U.S. Applications: Provisional Applications 61/550,552 filed Oct. 24, 2011; 61/563,377 filed Nov. 23, 2011; 61/569,490 filed Dec. 12, 2011; 61/584,438 filed Jan. 9, 2012; and 61/617,302 filed Mar. 29, 2012.

### BACKGROUND 1. Technical Field

Embodiments of the present invention relate generally to securities trading and, more particularly, to methods of automating trading based on the trading actions of other traders.

2. Description of Related Art

This discussion is intended to provide the basic context of this patent application and it is not intended to describe a specific problem to be solved.

With the advent of the Internet, trading platforms have been developed with software existing as websites to provide trading information and to enable investors to place their trade orders directly with the broker using platform application software and communicating via the Internet at lower cost than before.

It would be advantageous if there existed a system to display the expression of investment risk by simply adjusting an object of a Graphical User Interface.

### BRIEF SUMMARY

In one aspect, the present invention takes the form on an interactive control inside a web-based trading platform application that displays variables and calculated results that enables a user to select the characteristics of a specific investment strategy that is expected to provide acceptable profits within acceptable risks.

The user of the platform, after selecting his favorite signal providers according to their performance, location, rank, specialty, strategy of trading or other characteristics and activating them so for the system being able to follow their transactions, by using the said interactive control, he/she actually defines an amount of risk up to the value of which he/she accepts to challenge losing his/her investment in percentage from 0 to 100%, in specified increments, in the worst case scenario of when one or all signal providers will demonstrate the same poor performance again as in their historically worst drawdown.

The web-based platform is capable to offering higher quality of service with higher degree of security in the benefit of the user, not taught by the prior art.

The “amount” of maximum investment risk is now visualized by using a simple object of Graphical User Interface.

Another aspect of the present invention provides an interactive trading method for automating a user's trading based on the trading actions of one or more other specified traders, in correlation with a user-settable maximum risk graded value, the method including: receiving a user's defined risk value; calculating a risk per provider value; calculating a worst case lots value; calculating a hypothetical profit target; and calculating a number of lots for each signal provider.

An alternative aspect of the present invention provides an interactive trading method for automating a user's trading based on the trading actions of one or more other specified traders, in correlation with a user-settable maximum risk graded value, the method including: receiving a user's defined risk value; calculating the available capital; calculating the Necessary Minimum Equity value for each signal provider; calculating number of lots for each signal provider; adjusting the number of lots manually, if desired, by varying weighting factors.

Another aspect of the present invention provides an interactive trading method for automating a user's trading strategy that is based on the historic correlation between two or more currency pairs. This strategy is a business method in that an investor selects two highly correlated currency pairs, waits for a gap in their value to appear and then placing an order for buying the lower value pair and selling the higher value pair. Now when the gap becomes smaller the investor has profits and can stop trading by closing the opened positions. If the gap gets bigger the investor has losses and can wait for the gap to become smaller or stop loosing by closing positions. This method can now be done automatically without the need for the constant trader's attention, with higher speed, security and convenience, the method including: Selecting two or more currency pairs; defining the gap that will trigger an automatic placement; defining the amount invested per pair; defining stop-loss and take-profit amounts for the bulk placement altogether Complex and time consuming calculations necessary to perform allocation of the lots now are done in no significant time in the benefit of the user who selects this investment strategy.

The aforementioned and/or other features, aspects, details, utilities, and advantages of the present invention are: set forth in the detailed description which follows and/or illustrated in the accompanying drawings; possibly inferable from the detailed description and/or illustrated in the accompanying drawings; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a graphic illustrating a sliding bar on the web-page application that a user can visit and assign the amount of how much his investment may risk;

FIG. 2 is a block diagram illustrating the signaling of users by signal providers;

FIG. 3 is a graphic illustrating a list of signal providers;

FIG. 4 is a graphic illustrating a progression of the number of lots allocated per signal provider, per trade, when the risk is changed;

FIG. 5 is a graphic illustrating a signal provider's record;

FIG. 6 is a graphic illustrating another signal provider's record;

FIG. 7a and FIG. 7b are flowcharts illustrating a method consistent with an embodiment of the present invention;

FIG. 8 is a graphic illustrating a sliding bar on the web-page application that a user can visit and assign the amount of how much his investment may risk;

FIG. 9 is a graphic illustrating a list of signal providers;

FIG. 10 is a graphic illustrating a progression of the number of lots allocated per signal provider, per trade, when the risk is changed;

FIG. 11 is a flowchart illustrating a method consistent with a further embodiment of the present invention;

FIG. 12 is a graphic illustrating a balloon on the left of an opened trade a user sees onto the web-based application that denotes an incoming relevant message transmission from the signal provider;

FIG. 13 is a graphic illustrating a GUI mockup that allows the user to initiate or participate in a discussion;

FIG. 14 is a chart that illustrates the correlation of the Australian Dollar versus the US Dollar (AUD/USD) currency pair with the New Zealand Dollar versus the US Dollar (NZD/USD) currency pair values over a period of 18 years;

FIG. 15 is a chart that illustrates the correlation of the AUD/USD value with the NZD/USD value over a period of 4 hours;

FIG. 16 is a chart that illustrates a gap (temporary correlation decrease) between two currency pairs, again of the AUD/USD and NZD/USD, that would generate an automated position opening trigger signal;

FIG. 17 is a graphic illustrating a web page example of a profitable situation, where the two correlated currency pairs values converge;

FIG. 18 is a flowchart illustrating a method of an automated trading;

FIG. 19 is a graphic that illustrates the grouped overall profit or loss by using colors and example of GUI implementation designed to ease user interaction designed on an example mockup;

FIG. 20 is a graphic that illustrates the grouped overall profit or loss by using colors and example of GUI implementation designed to ease user interaction designed on an example mockup;

FIG. 21 is a graphic illustrating another example of a GUI used into a web-based trading platform;

FIG. 22 is a graphic illustrating an example of a table having multiple columns as displayed on a screen;

FIG. 23 is a graphic illustrating the same table as in FIG. 22, but with the column “Pips” and column “Trade”, position interchanged by manual control of the user;

FIG. 24 is a graphic illustrating the “win%” column in focus mode (high-contrasted);

FIG. 25 is a graphic illustrating the “Amount Following” column emphasized by changing column's background color;

FIG. 26 is a graphic illustrating the prompt the user can activate and choose between “highlight”, “focus” and “sort” selections for every table column;

FIG. 27 is a graphic illustrating the selected signal providers and the selection of the time filter;

FIG. 28 is a graphic illustrating the weekly schedule of following or not following the opening of new trade positions of the selected signal provider, on an hourly basis;

FIG. 29 is a graphic illustrating the capital protection function of the Zuluguard™ protection scheme and the selected actions to be taken if the loss exceeds the threshold value;

FIG. 30 is a graphic illustrating the pips amount threshold function of the Zuluguard™ protection scheme and the selected actions to be taken if the loss exceeds the threshold value; and

FIG. 31 is a graphic illustrating the embedded Virtual Personal Server the website system offers to the users by allowing them free resources of computer power and storage space from their own computer for heavy and complex processing tasks.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

Although the following text sets forth a detailed description of at least one embodiment or implementation, it is to be understood that the legal scope of protection of this application is defined by the words of the claims set forth at the end of this disclosure. The detailed description is to be construed as exemplary only and does not describe every possible embodiment since describing every possible embodiment would be impractical, if not impossible. Numerous alternative embodiments and/or implementations are both contemplated and possible, using either current technology or technology developed after the filing date of this patent, which would still fall within the scope of the claims.

It is to be understood that, unless a term is expressly defined in this application using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

As used herein, the term user means an individual who has registered in the system.

As used herein, the term signal provider means another specified trader selected and activated by a user. A signal provider provides trading “signals” through advice or actual trades, which the user seeks to mimic.

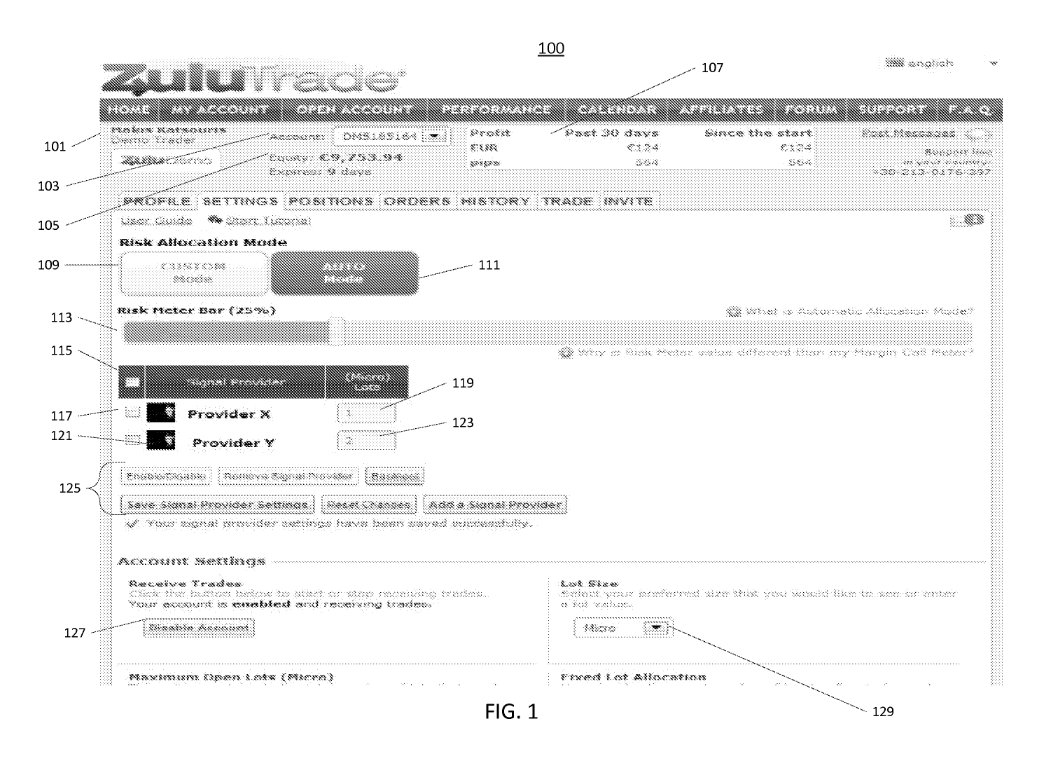

FIG. 1 is a graphic illustrating a sliding bar 113 on the web-page application 100 that a user 101 can visit and assign the amount of how much of his investment he may risk. On web page 100, user 101 is assigned account number 103. Web page 100 further displays user 101's equity position 105 and sub display 107 displays recent changes in the user 101's account for the past 30 days.

Web page 100 also provides a list of signal providers 115 that user 101 has subscribed to. These include Provider X 117 and Provider Y 121. Each of Provider X 117 and Provider 121 have Micro-Lots 119 and 123 allocated to them respectively. Web page 100 further provides enabling/disabling, removing, adding, saving and resetting a signal provider 125. The user 101 may also temporarily disable 127 his account and change the lot size by pull down 129.

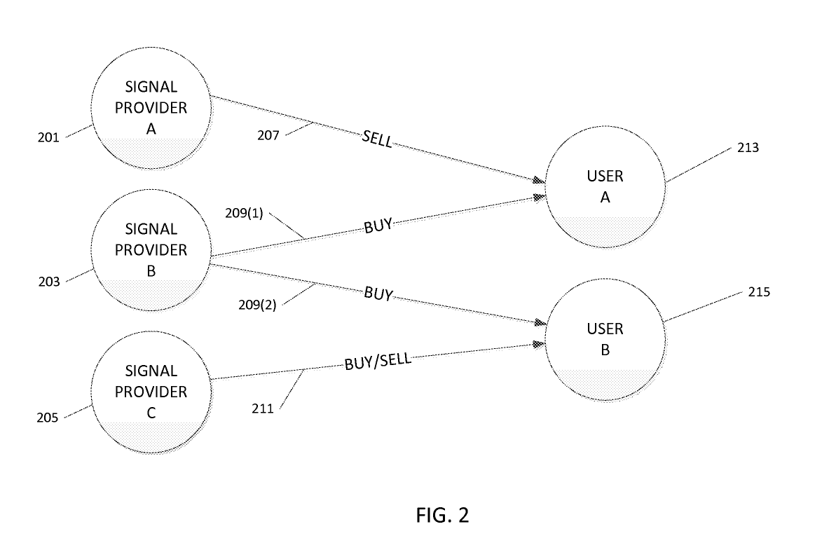

FIG. 2 is a block diagram illustrating the signaling of users by signal providers. In an example of signaling, Signal Provider A 201, Signal Provider B 203, and Signal Provider C 205 provide trading information (i.e. signals) to a number users. Here, User A 213 and User B 215 subscribe to Signal Provider A 201 and Signal Provider B 203. While User B 215, subscribes to Signal Provider B 203, and Signal Provider C 205 User A receives signal 207 from Signal Provider A 201 to sell a position; while Signal Provider B 203 instructs 209(1) User A 213 to buy a position. The same signal 209(2) is also transmitted to User B 215. User B also receives a signal 211 to buy and sell along with other information from Signal Provider C 205. It is understood that the signal may be to buy or sell, or set parameters for the buying and selling of an investment.

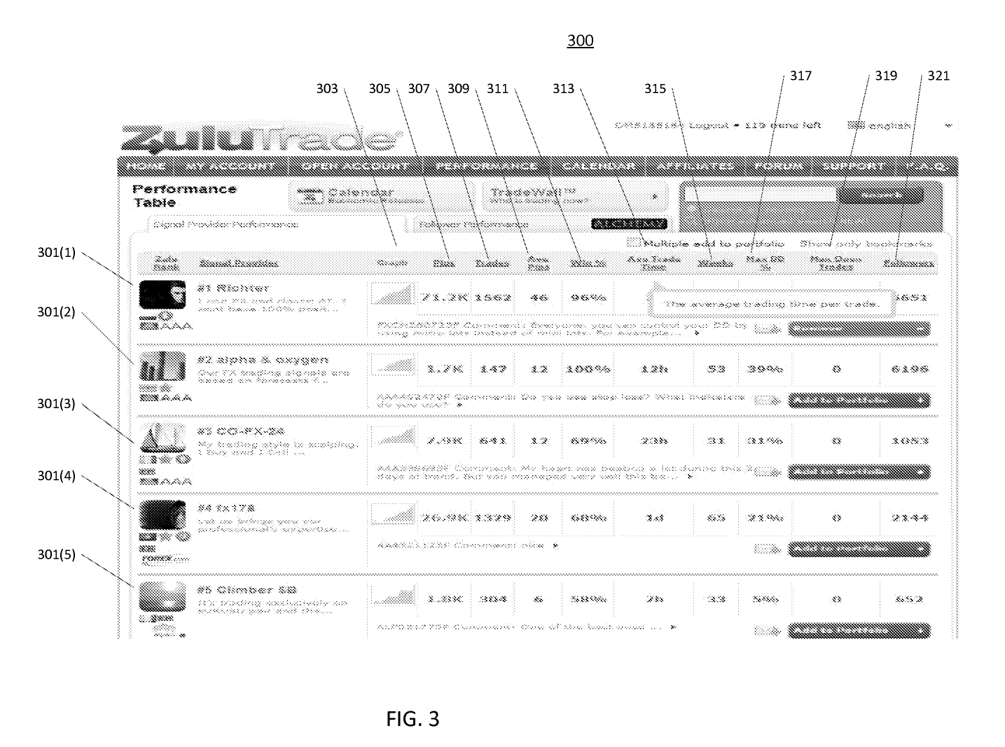

FIG. 3 shows an example of a signal providers list 300 which contains description and historic performance information for every one of signal providers so that the user can choose according to his/her investment strategy. Signal providers 301(1)-(5) are a subset of signal providers and the set of signal providers is larger than shown. The historic performance information for every signal provider 301(1)-(5) is shown as a bar graph 303. Pips 305 as used herein, is a minimum unit of movement of a currency upwards or downwards. A pip is the smallest price change that a given exchange rate can make while fluctuating. Since most major currency pairs are priced to four decimal places, the smallest change is that of the last decimal point—for most currency pairs this is the equivalent of 1/100 of one percent, or one basis point.

Trades 307 are the number of trades ascribed to a particular signal providers 301(1)-(5). Average Pips 309 are the total pips 305 divided by the number of trades 307. The web page 100 further displays percentage of wins 311, average trade time 313, weeks 315 the signal provider has been active, Max DD % 317. Max DD is the peak to valley drawdown for a currancy pair. The web page 300 also provides the number of open trades 319 and followers 321 of each signal provider 301(1)-(5).

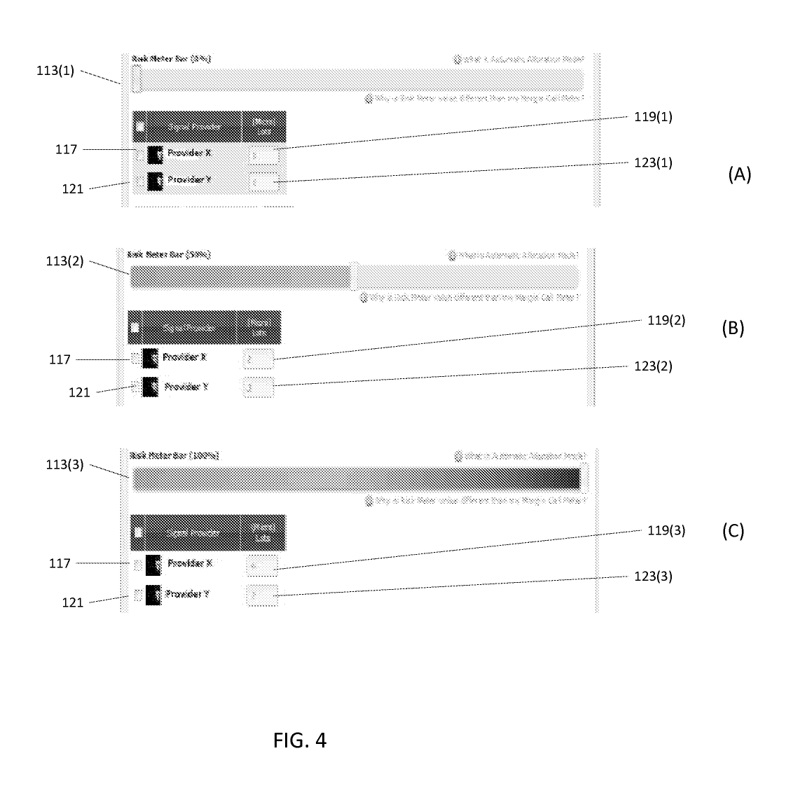

FIG. 4 is a graphic illustrating a progression of the number of lots allocated per signal provider, per trade, when the risk is changed. In panel 10(A) the risk is zero 113(1). Provider X 117 has 1 micro lot 119(1) assigned to him and Provider Y 121 has 1 micro lot 123(1) is assigned to him. When the risk is set to 50% 113(2) in panel 10(B), Provider X 117 has 1 micro lot of “2” 119(2) is assigned to him and Provider Y 121 has 1 micro lot of “3” 123(2) assigned. When the risk is set to 100% 113(3) in panel 10(C), Provider X 117 has 1 micro lot of “4” 119(3) assigned to him and Provider Y 121 has 1 micro lot of “7” 123(2) is assigned.

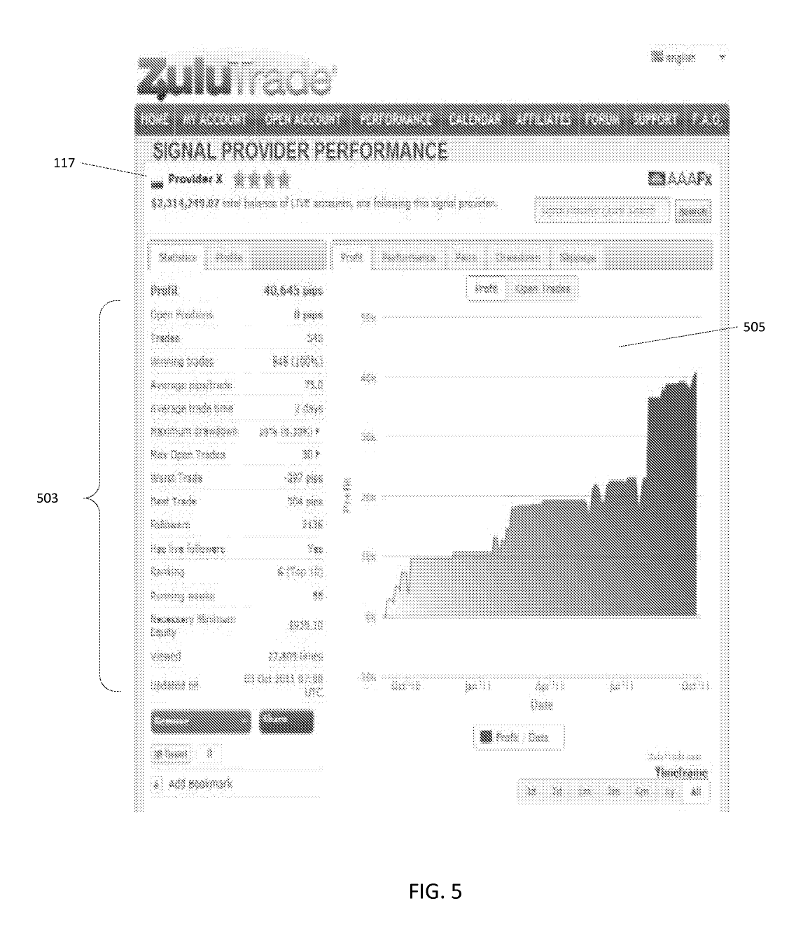

FIG. 5 is a graphic illustrating a signal provider's record. For Provider X 119, show a list of metrics 503 and a bar chart 505 of the signal provider's performance.

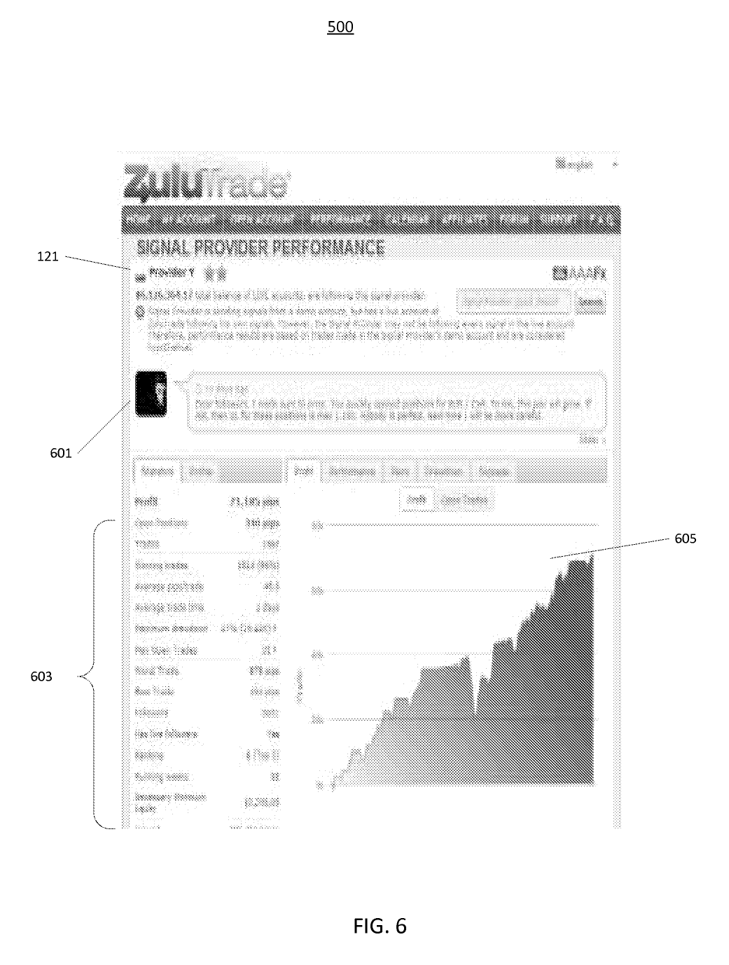

FIG. 6 is a graphic illustrating another signal provider's record. For Provider Y 119, show a list of metrics 603 and a bar chart 605 of the signal provider's performance. Additionally, display in a sub panel message 601 from Provider Y 119.

As used herein, the term web site means a computer system that serves informational content over a network using a network protocol. Such a protocol may be standard and proprietary. One example protocol is Hyper Text Transfer Protocol (HTTP) that is used in World Wide Web (WWW) today. As used herein, the term is generally intended to encompass both (i) the hardware/software server components that serve the informational content over the network, and (ii) the “back end” software and hardware components, including any non-standard or specialized components, which interact with the server components to perform services for the web site users.

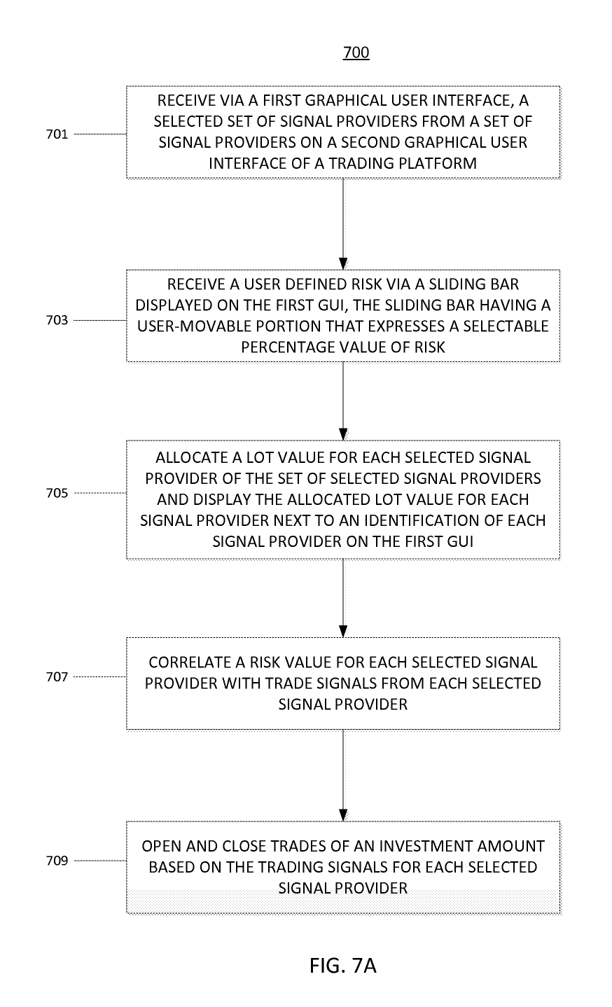

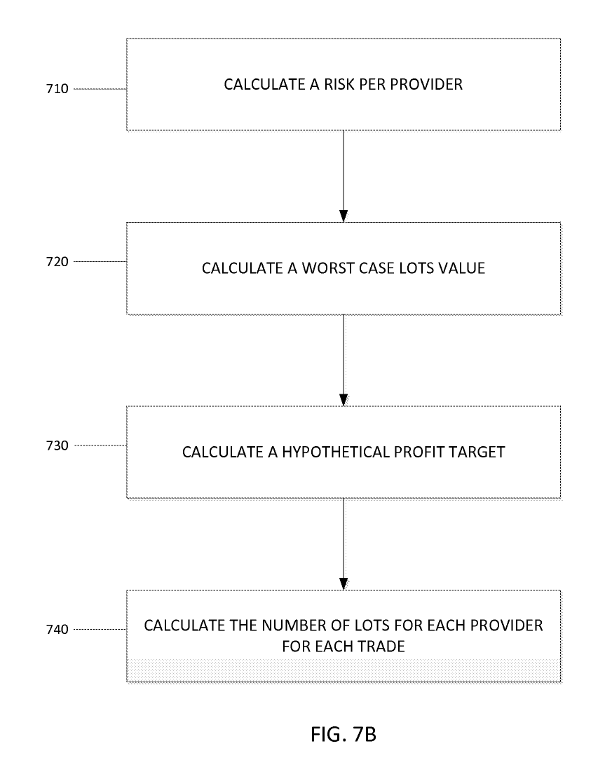

FIG. 7A and 7B are flowcharts illustrating a method consistent with an embodiment of the present invention.

Referring now to FIG. 7A, there is illustrated a method 700 consistent with an embodiment of the present invention. The method 700 includes receiving 701, via a first graphical user interface 100, a selected set of signal providers 117, 121 from a set of signal providers 301(1)-(5) on a second graphical user interface 300 of a trading platform and displaying the set of selected signal providers 117, 121. Next, receiving, via the first graphical user interface 100, a user defined risk via a sliding bar 113 displayed on the first graphical user interface 100, the sliding bar having a user-movable portion that expresses a selectable percentage value of risk. Then, when the risk is acquired, allocate 705 a lot value 119, 123 for each selected signal provider 117 or 121 of the set of selected signal providers 117 and 121 and displaying the allocated lot value 119, 123 for each signal provider 117 and 121 next to an identification of each signal provider 117 and 121 of the set of selected signal providers 301(1)-(5) on the first graphical user interface 100. Next, correlate 707 a risk value for each selected signal provider 117 and 121 with trade signals from each selected signal provider 117 and 121. Finally, open and close trades of an investment amount based on the trading signals for each selected signal provider 117 and 121.

Referring to 7B, the step of allocating lots 705 includes the following operations: calculating a risk per provider value (operation 710); calculating a worst case lots value (operation 720); calculating a hypothetical profit target (operation 730); and calculating a number of lots for each signal provider (operation 740).

Next, in operation 710, the web-based trading platform application calculates a “risk per provider value” based on the user's account balance and the number of signal providers currently selected and activated. The “risk per provider value” is an amount of money the user may risk per selected and activated signal provider. This value is computed by multiplying the user's current account balance by the value of the set risk divided by 100 and then dividing that result by the number of the active signal providers (i.e., the number of providers associated to the account's portfolio). This computation is expressed by the following equation:

$${Risk}_{provider} = \frac{Balance * ( risk / 100 )}{{Providers}_{count}}$$

Next, in operation 720, a worst case lots (a lot being a contract unit) is calculated, based on the one of the signal providers that demonstrates the worst drawdown from all other active signal providers. A standard lot is a buy or sell size. For example, if a user buys 1 lot of EUR/USD, trading at 100:1 leverage then the user actually buys 100,000 EUR/USD. But if trading with a e.g. 100:1 leverage, the leveraged value is 1,000 EUR/USD or 1 standard lot. If the user trades a mini lot, then the user buys 10,000 EUR/USD and the leveraged value is 100 EUR/USD or 1 mini lot. This value is calculated by dividing the risk per provider value calculated in operation 701 by the result of product of the maximum drawdown value of the provider and a dollar value “DollarValue” (an amount of dollars per pip for standard lot contracts as defined by the platform application). The DollarValue is used to convert numbers into real money. It is actually the value of an account balance expressed in U.S. Dollars, for example. For example, the user may have a EURO account. So the Dollar Value in this example is 1.3. This number (1.3) is used to convert the users account balance value expressed in US Dollars. If the account is in USD, the Dollar Value term is 1. This computation is expressed by the following equation:

$$WorstCaseLots = \frac{{Risk}_{provider}}{{MaxDrawdown}_{provider} * DollarValue}$$

Then, in operation 730, a hypothetical profit target is calculated using the “worst case lots” value computed in operation 720. Using the “worst case lots” value, the hypothetical target profit based on provider's annual performance is calculated by multiplying the “worst case lots” value by the “profit of worst provider” by the dollar value. This computation is expressed by the following equation:

Profit_{target}=WorstCaseLots*Profit_{woprovider}*DollarValue

Thereafter, in operation 740, a number of lots (i.e., an investment amount) for each signal provider (“Lots per Provider”) is calculated on the basis of their annual performance. This is done by using the “profit target” calculated in operation 730 and calculating the number of lots that can be assigned to each provider in the user's portfolio to verge on this profit, on the basis of signal providers' annual performance. Taking into account the providers' worst annual performance, the application allocates the profit target, as set with the risk sliding bar 113, on all activated signal providers. And this is used to calculate the lots/provider. ( . . . setting 100% risk means I am up to 100% profit). This Lots per Provider value is calculated by dividing the “Profit target” calculated in operation 730 by the product of his Pips per provider and the dollar value. This computation is expressed by the following equation:

$${Lots}_{provider} = \frac{{Profit}_{target}}{{Pips}_{provider} * DollarValue}$$

### EXAMPLE

A user of the web-based trading platform selects one signal provider that displays a good record on trading foreign exchange over the time period of last year. FIG. 4 panel (B) shows one example, Provider X 117, who in a period of a year has demonstrated very good performance over profits, low failures and constant advancement. The user also selects another one, thinking that it is better to rely his/her investment on more than one signal provider and chooses to add a second signal provider, Provider Y 121 (see FIG. 4 panel (C)) of similar historical record. With those two signal providers now selected and activated (i.e., the user may have chosen many signal providers and have them in a list, but activates one, a few or all of them when desired), the number of allocated lots per signal provider, per trade, are automatically calculated and shown next to their names with the risk meter bar set at 100% (as in FIG. 4 panel (C)). These are 4 lots for Provider X 117 and 7 lots 123(3) for Provider Y 121. With the risk meter bar at 50% 113(2) and at 0%, the number of allocated lots per signal provider per trade is shown next to their names as in FIG. 4 panel (B) (“2” 119(2) for Provider X 117 and “3” 123(2) for Provider Y 121) and in FIG. 4 panel (A) respectively (“0” lots 119(1) for Provider X 117 and “0” lots 123(1) for Provider Y 121). The risk undertaken can be more than 100% and FIG. 5 showed a setting of 150%. Until this automation set-up is terminated by the user 101, for any trades the signal provider executes, the associated profit or loss scaled down to the user's individual lot size multiplied by the number of lots is recorded in his/her account balance.

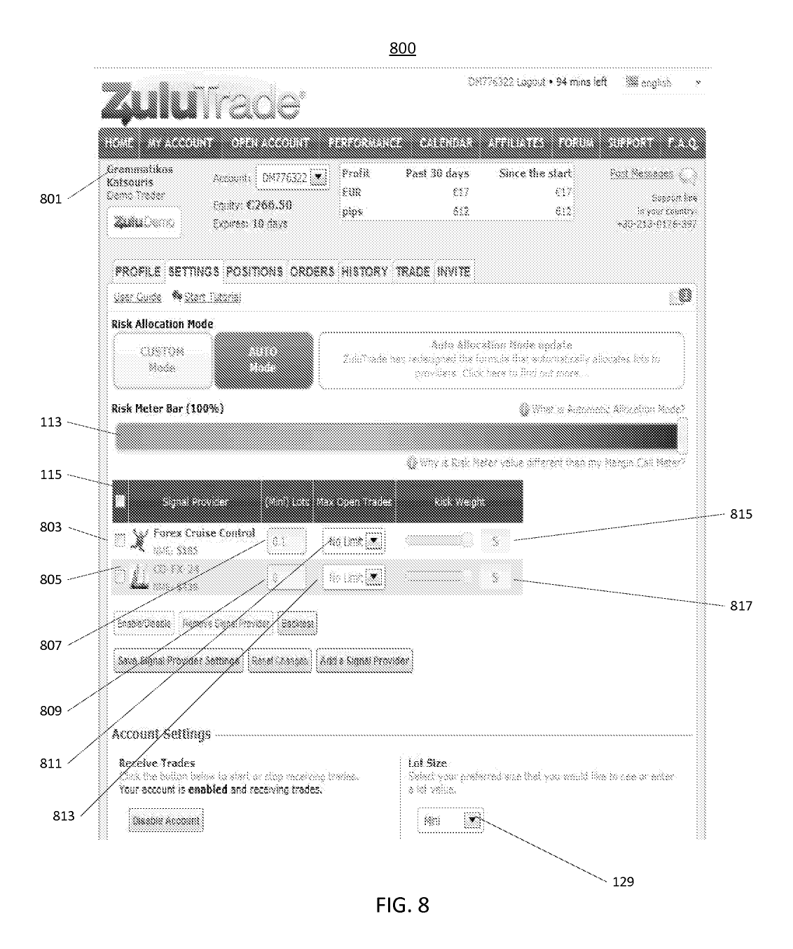

FIG. 8 is a graphic illustrating a sliding bar 113 on the web-page application 800 that a user 801 can visit and assign the amount of how much his investment may risk. On web page 100, user 101 is assigned account number 103.

Web page 800 also provides a list of signal providers 115 that user 801 has subscribed to. These include Provider Forex Cruise Control 803 and Provider CD-FX-24 805. Each of Provider Forex Cruise Control 803 and Provider CD-FX-24 805 have micro-Lots 807 and 809 allocated to them respectively. Web page 800 further provides setting limits on open trades 811 and 813 for each signal provider 803 and 805 respectively. The user 801 may also change the lot size (mini lots) by pull down 129.

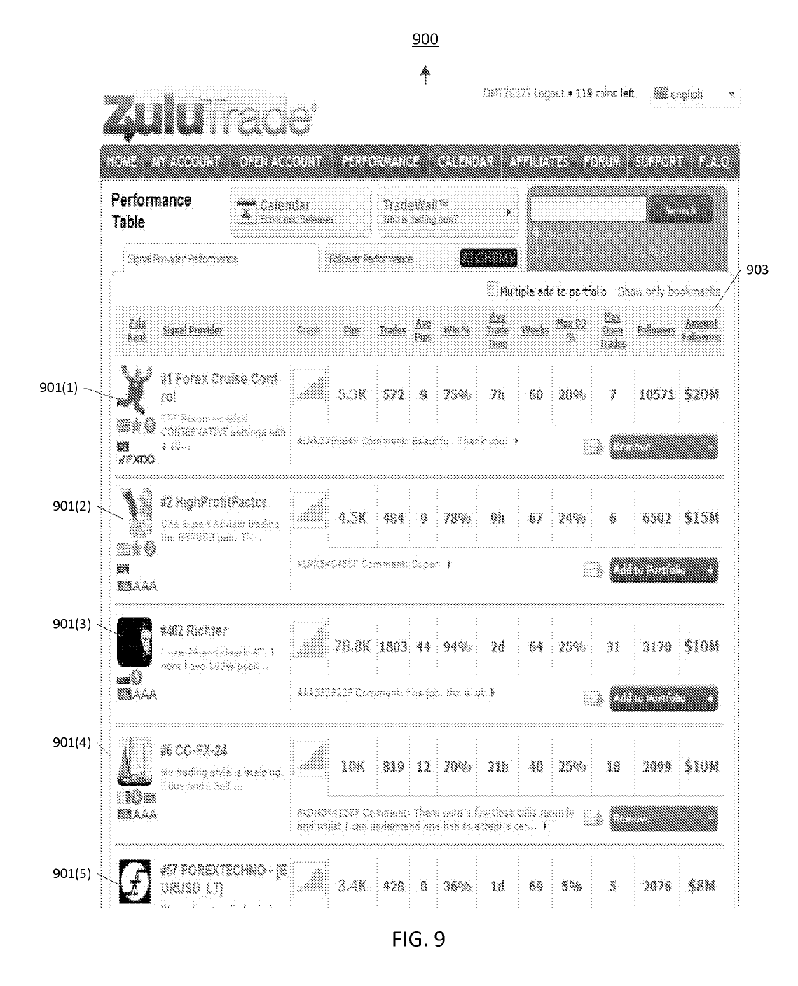

FIG. 9 is a graphic illustrating an example of a signal providers list 900 which contains description and historic performance information for every one of them so that the user can choose according to his/her investment strategy. Signal providers 901(1)-(5) are a subset of signal providers and the set of signal providers is larger than shown. The historic performance information for every signal provider 901(1)-(5) is shown in the same manner as in FIG. 3. Additionally, the signal providers list 900 has a column 903 indicating the amount of currency following a particular signal provider 901(1)-(5).

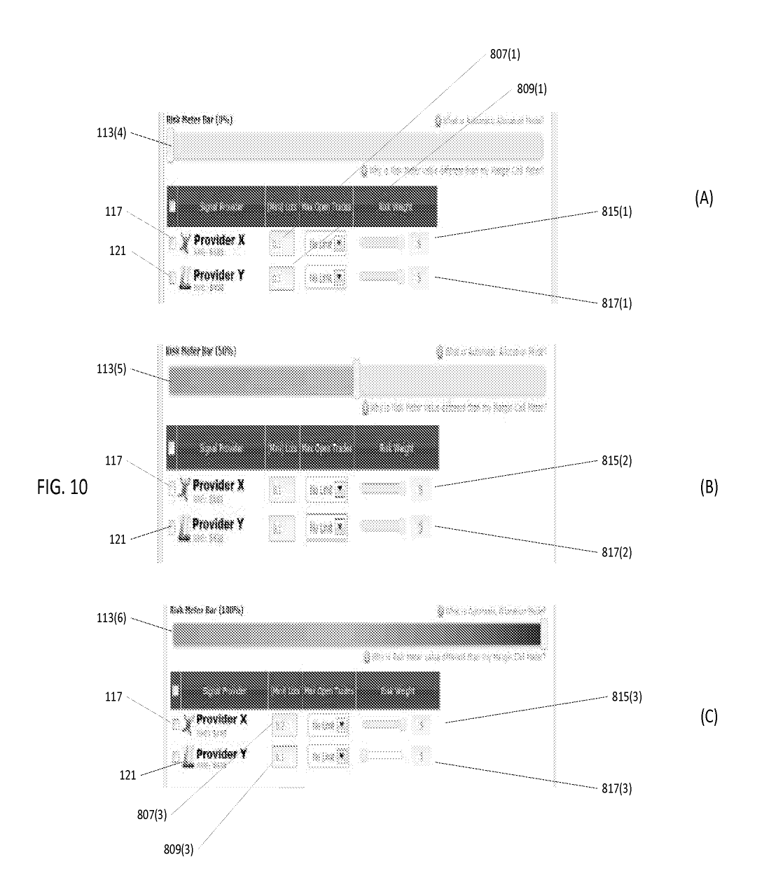

FIG. 10 is a graphic illustrating a progression of the change in Risk Weight per signal when the risk is changed. In panel 10(A) the risk is zero 113(4). Provider X 117 has “0.1” mini lots 807(1) and Provider Y 121 has “0.1” mini lots 809(1), with the corresponding risk weight calculated to be “5” 815(1) and “5” 817(1). When the risk is set to 50% 113(5) in panel 10(B), Provider X 117 has 0.1 mini lot and Provider Y 121 has mini lot of “0.1”. Correspondingly with the When the risk is set to 50% 113(5) in panel 10(B) the risk weight is still calculated to “5” 815(1) and “5” 817(1). When the risk is set to 100% 113(6) in panel 10(C), Provider X 117 has 1 mini lot of “0.2” 807(3) and Provider Y 121 has mini lot of “0.1” 809(3) with a corresponding Risk Weight calculated to be “5” 815(3) and “1” 817(3).

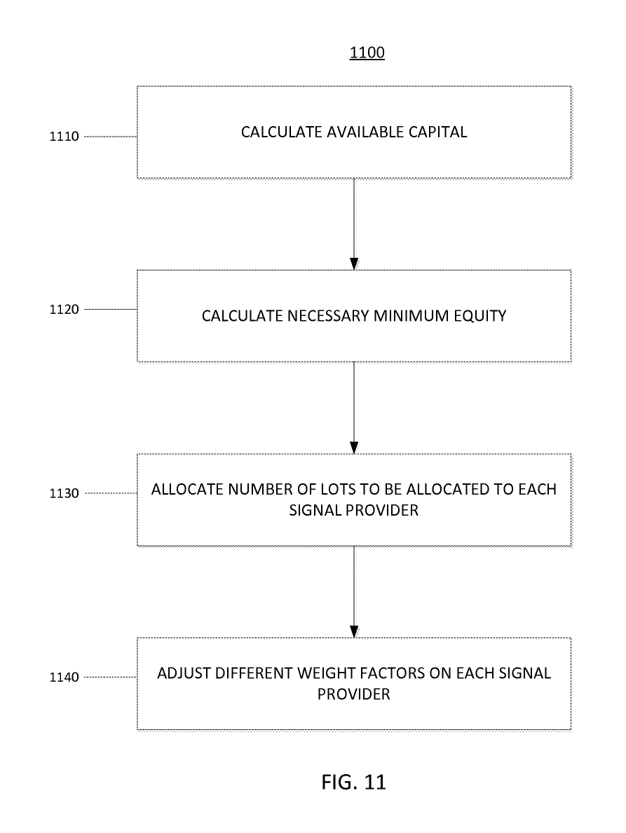

FIG. 11 is a flowchart illustrating a method 1100 consistent with an alternative embodiment of step 705. The method 1100 includes the following operations: calculating the available capital (operation 1110); calculating Necessary Minimum Equity (operation 1120); calculating number of lots to be allocated by each signal provider (operation 1130); modifying the number of lots to be allocated by each signal provider by a user defined weight factor (operation 1140).

In operation 701, after the user 801 of the platform selects one or more signal providers 115, an interactive control lets the user 801 define (i.e., set) a risk value 113. The risk value may be set manually and may be incrementally graded from 0 to 100%. The increments may be, for example, 1%.

Next, in operation 1110, the web-based trading platform application calculates an “available capital” value based on the user's account balance and the amount of risk as entered by the user above. The “available capital” is an amount of money the user may risk per selected and activated signal provider (117 or 121). This value is computed by multiplying the user's 801 current account balance 105 by the value of the set risk divided by 100. This computation is expressed by the following equation:

Capital_{available}=Balance*(^{risk}/₁₀₀)

Next, in operation 1120, the web-based trading application calculates the Necessary Minimum Equity (NME). The NME is in USD and it is the required capital to trade each provider. It is given from the following calculation:

NME (in USD)=Max Provider Drawdown in Pips+Max Open Trades×10

Here, the application looks for the annual (or other long timeframe as programmed by the application) performance of the selected signal provider into its database of transactions and finds the worst drawdown in pips he/she has made in the past. Using this number and adding the current maximum open trades and multiplying by 10 gives the NME.

Next, in operation 1130, using the available capital and the NME found in the previous steps, the number of lots that can be assigned to the provider in user's 801 portfolio is calculated. This computation is expressed by the following equation:

$${Lots}_{provider} = \frac{{Capital}_{available}}{{NME}_{provider}}$$

Next, in operation 1140, the user 801 can manually adjust the allocation of the capital differently to each signal provider (117 and 121) by adjusting different weight factors on each of them. Those weight factors affect the number of allocated lots per signal provider as in the following equation:

$${Lots}_{provider} = \frac{{Capital}_{available}}{{NME}_{provider}} * \frac{{Weight}_{provider}}{{Weight}_{total}}$$

Example: A user 801 of the web-based trading platform selects one signal provider (117 or 121) that displays a good record on trading foreign exchange over the time period of last year. FIG. 5 shows one example, Provider X 117, who in a period of a year has demonstrated very good performance over profits, low failures and constant advancement. The user 801 also selects another one, thinking that it is better to rely his/her investment on more than one signal provider and chooses to add a second signal provider, Provider Y 121 (FIG. 6) of similar historical record. With those two signal providers now selected and activated (i.e., the user may have chosen many signal providers and have them in a list, but activates one, a few or all of them when desired), the number of allocated lots per signal provider, per trade, are automatically calculated and shown next to their names with the risk meter bar set at 100% 113(6) (as in FIG. 10 panel (C)). These are 0.2 minilots 807(3) for Provider X 117 and 0.1 minilots 809(3) for Provider Y 121. With the risk meter bar at 50% 113 (5) and at 0% 113(4), the number of allocated lots per signal provider per trade is shown next to their names as in FIG. 10 panel (B) (“0.1” for Provider X 117 and “0.1” for Provider Y 121) and in FIG. 10 panel (A) respectively (“0.1” 807(1) for Provider X 117 and “0.1” 809(1) for Provider Y 121). Until this automation set-up is terminated by the user 801, for any trades the signal provider executes, the associated profit or loss scaled down to the user's 801 individual lot size multiplied by the number of lots is recorded into his/her account balance.

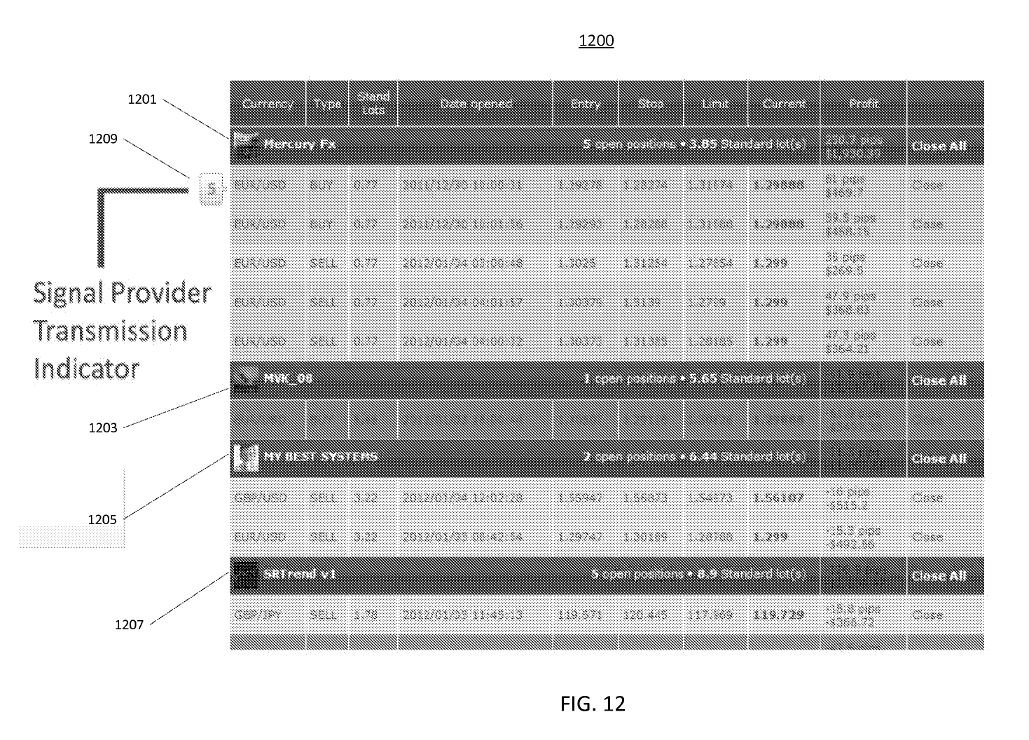

FIG. 12 is a graphic illustrating of a window 1200 displaying a balloon denoting an incoming relevant message transmission from the signal provider. The window 1200 contains a list of relevant signal providers 1201, 1203, 1205, and 1207. The balloon 1209 indicates a message is available from the signal provider 1209.

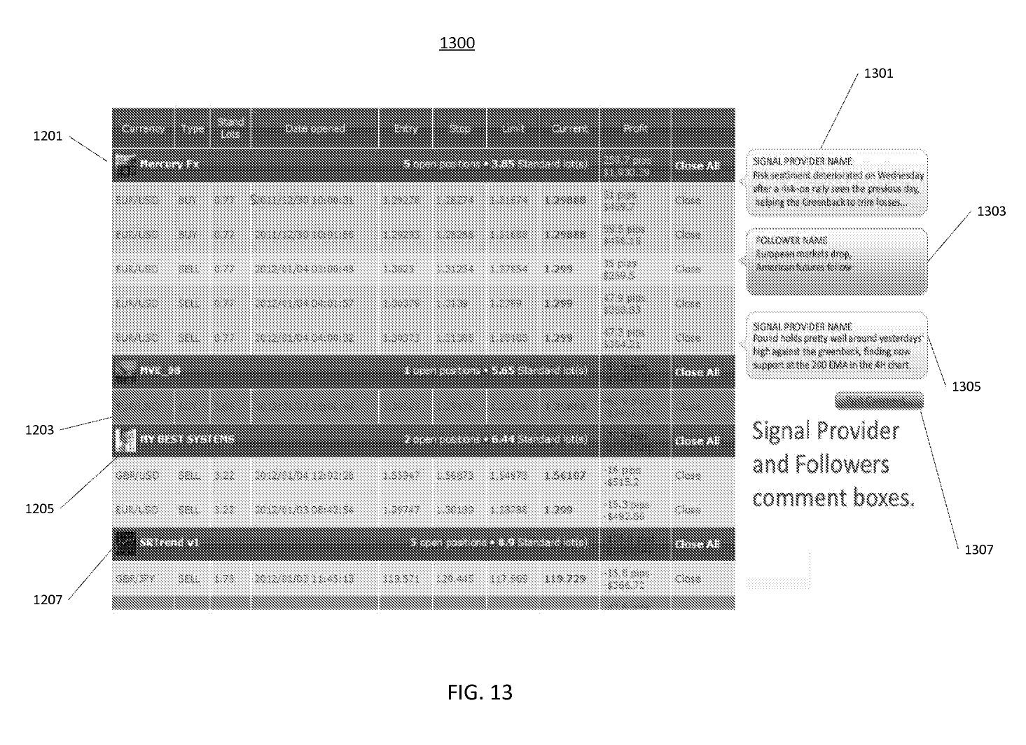

FIG. 13 is a graphic illustrating a GUI mockup 1400 that allows the user to initiate or participate in a discussion. Signal provider 1201 initiates a first message 1301 containing a comment that is displayed to user 101 and user 101 replies with message 1303. Signal provider 1201 initiates a second message 1305. It is understood that user 101 may further reply using button 1307 and entering text in a display panel (not shown).

By using this Graphical User Interface window 1300, the user 101 who chooses to follow the strategy of trading with messages 1301 and 1305 coming from the signal provider 1201 with discussion threading, performs a very complex and time consuming procedure which is now easily and interactively feasible at virtually no cost in money and time by integrating the capability on-line on the website application.

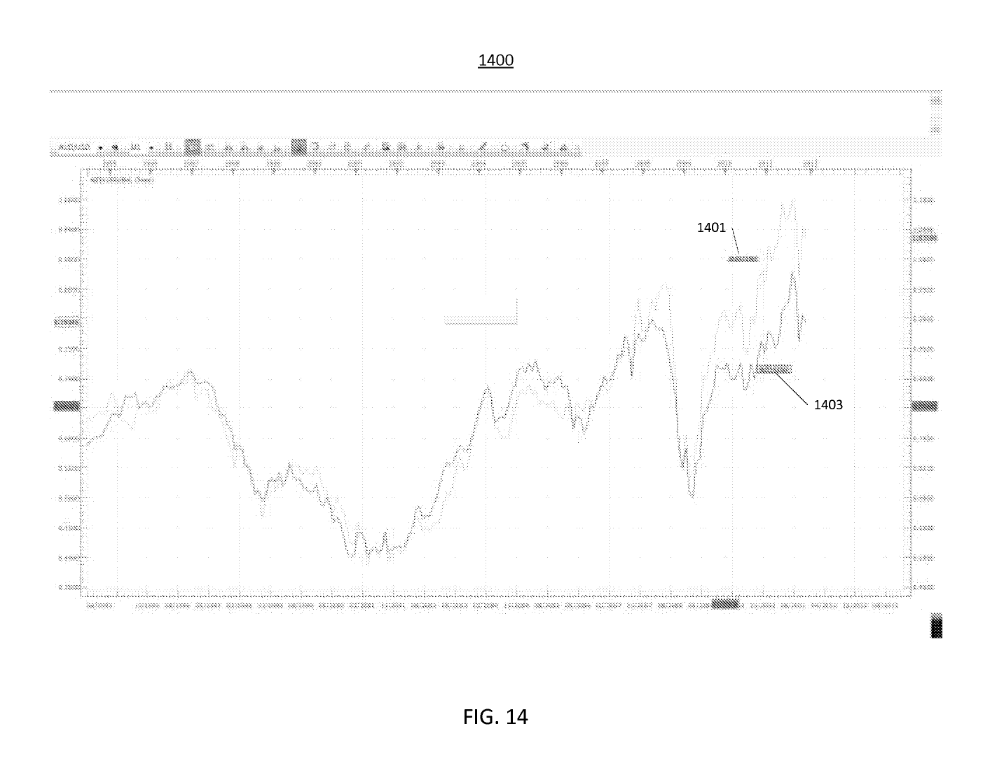

FIG. 14 is a chart that illustrates the correlation of the Australian Dollar versus the US Dollar (AUD/USD) currency pair with the New Zealand Dollar versus the US Dollar (NZD/USD) currency pair values over a period of 18 years. FIG. 14 illustrates the example of the high correlation between the AUD/USD 1401 and the NZD/USD 1403 currency pairs value during the period of the last 18 years. It demonstrates their strong correlation over time in that when the one goes up or down in value, the other follows.

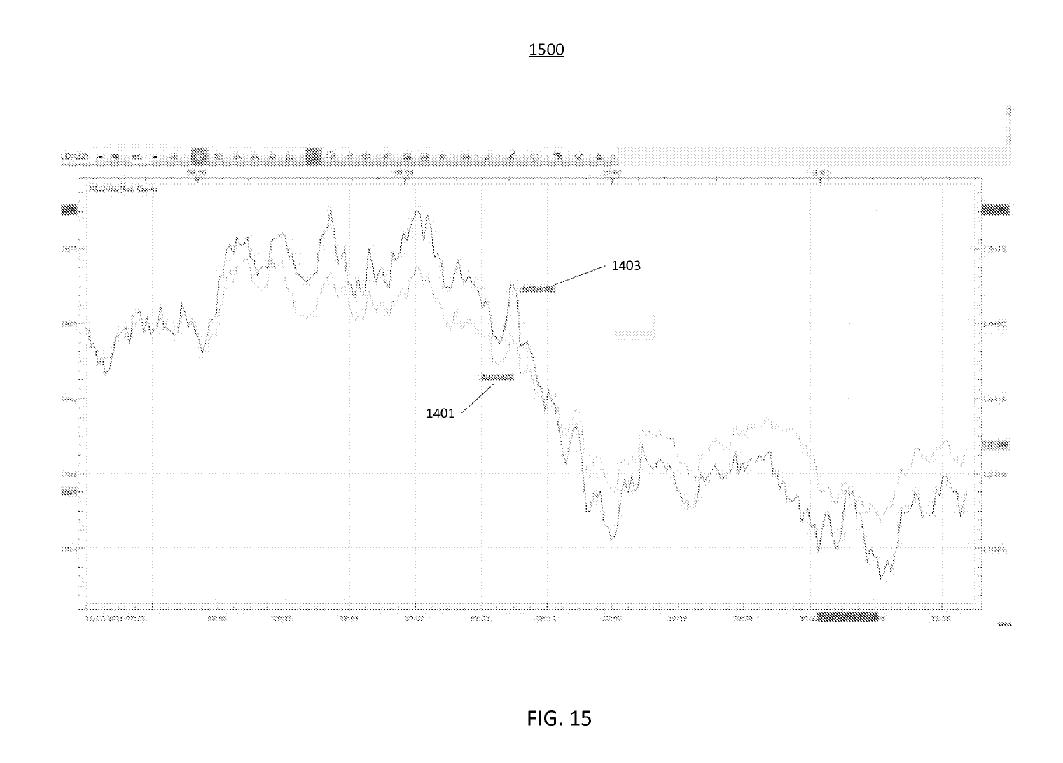

This is also valid in very short time frames as illustrated in FIG. 15 where the correlation of their values is shown again for a period of 4 hours only. The investment idea is displayed as in

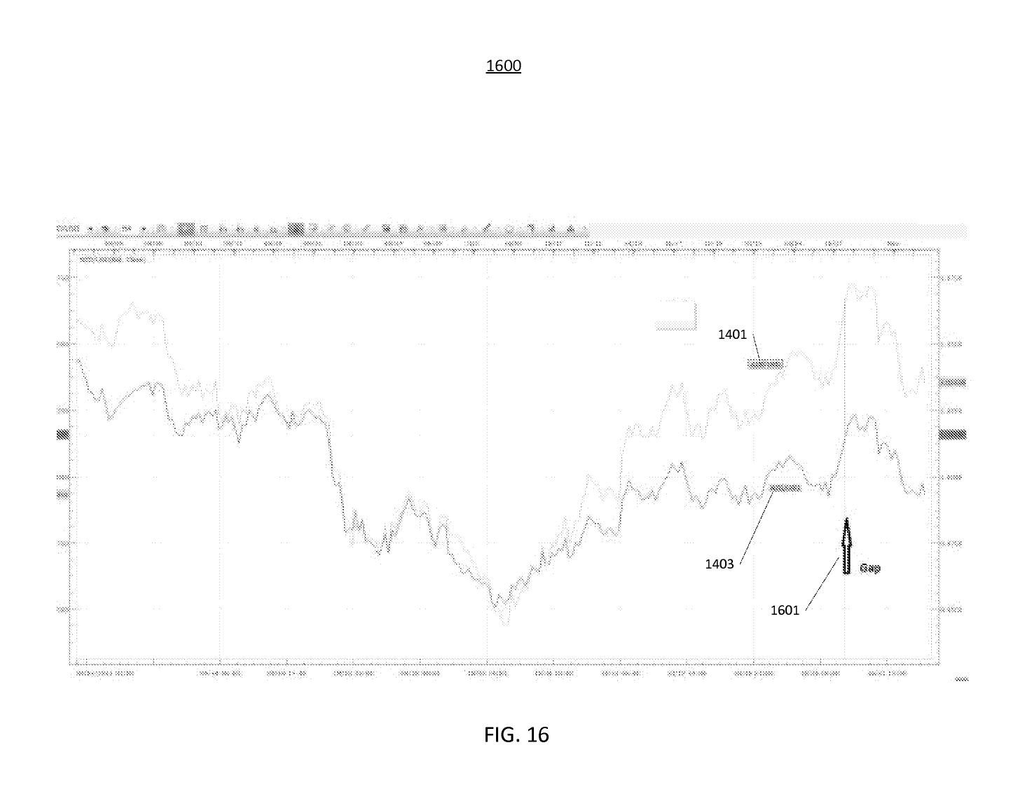

FIG. 16 illustrates where the investor waits for a gap 1601 in their values to occur, i.e. their value correlation to decrease for a while and then immediately buy the lower value pair and sell the higher value pair. It is unlikely for their values to increase the gap further or even if this is really done, it is not expected to last for a long time. If the lower value pair will move up and the higher value pair will move down, the investor gets big profits from both pairs and in most other combinations will get earnings from the one pair and losses from the other in a way that of protecting the initial investment by “hedging” i.e., losses from the one pair would be compensated from the other pair's profits.

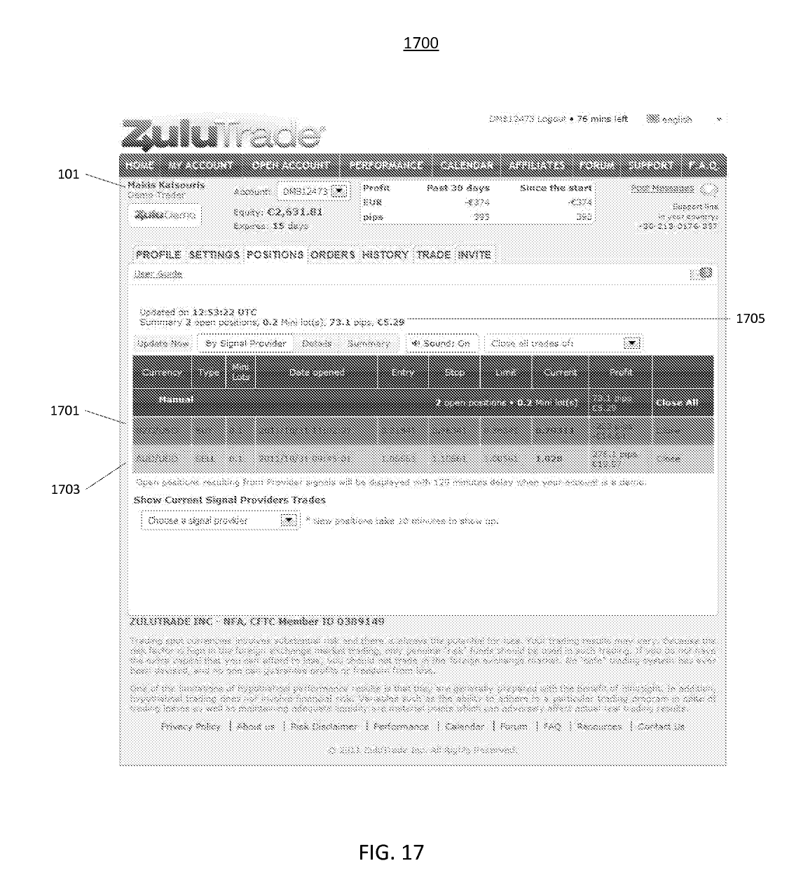

This is shown in FIG. 17 where for user 101 the loss of the first pair 1701 is compensated by the earnings of the second pair 1703, giving a combined small profit 1705. The investor now waits for a profitable combination to occur in order to close the trade positions and take the profits or a limited loss combination in order to close positions and stop losing.

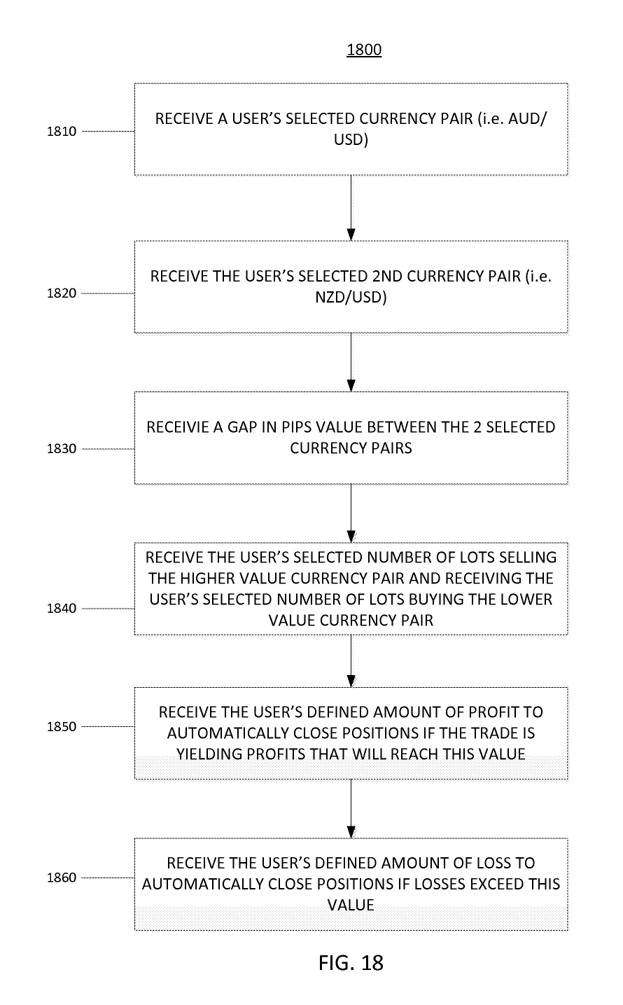

Referring now to FIG. 18, there is illustrated an automated trading method 1800 consistent with a further embodiment of the present invention.

The method 1800 receiving a user's selected currency pair 1403 (operation 1810); receiving the user's 101 selected 2nd currency pair 1401 that has or seems to have a high correlation coefficient to the 1st pair 1403 (operation 1820); receiving a gap 1601 in pips value between the 2 selected currency pairs 1401 and 1403 (operation 1830); receiving the user's 101 selected number of lots selling the higher value currency pair and receiving the user's selected number of lots buying the lower value currency pair (operation 1840); receiving the user's defined amount of profit to automatically close positions if the trade is yielding profits that will reach this value(operation 1850); receiving the user's defined amount of loss to automatically close positions if losses exceed this value (operation 1860).

In operation, the method 1800 is of a web-based application receiving input through a Graphical User Interface and getting the 1st selected currency pair 1403 with the associated command of going short (selling) or going long (buying), then getting the 2nd currency pair with the associated command of going short (selling) or going long (buying), then getting the user defined gap between the currency pairs values in pips that when fulfilled the application will proceed and execute the positions opening, then getting the quantity of the trades in lots, then getting the value on which the application will close positions in the case of profit, then getting the value on which the application will close positions in the case of loss.

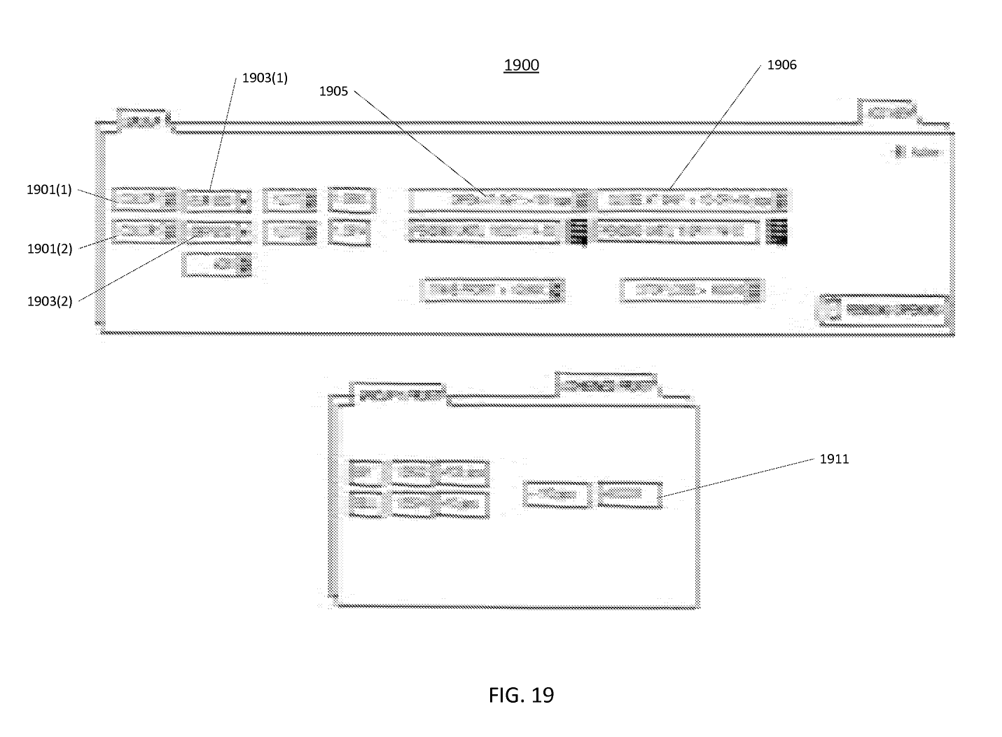

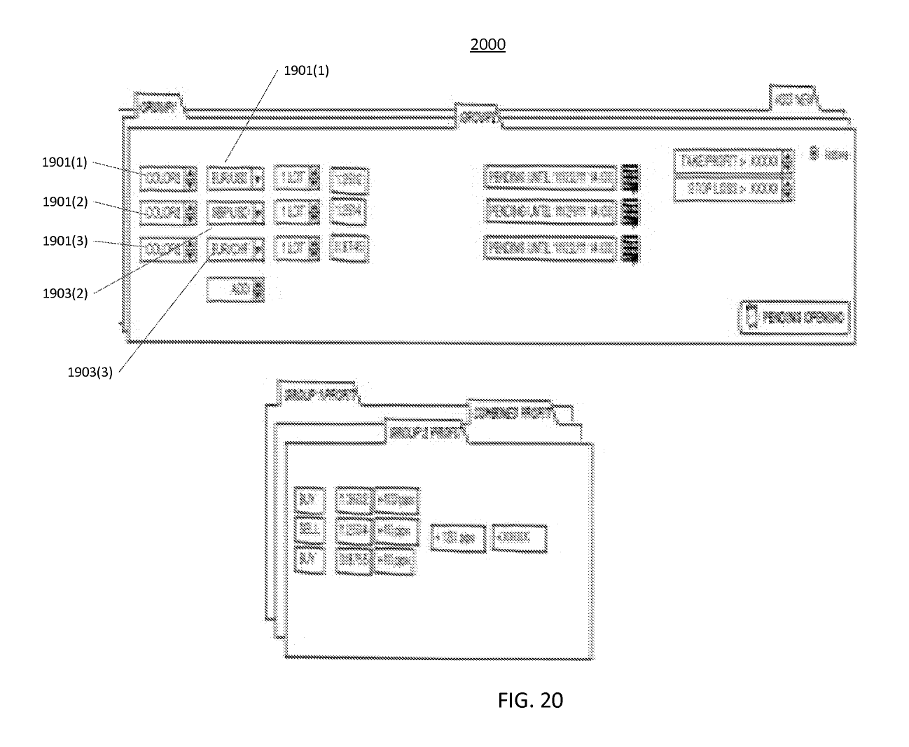

FIG. 19 shows the grouped overall profit or loss by using colors and example of GUI implementation designed to ease user interaction designed on an example mockup. GUI mockup example 1900 for automating the correlated currency pairs 1903(1 and 2) trading in a web-based application, consistent with an embodiment of the present invention and in GUI example 1900, the user 101 can define the gap between two currency pairs 1903(1 and 2) for opening positions 1905. The user may add more currency pairs and keep them grouped 1909 together so the algebraic sum will be displayed as the overall loss or profit 1911. The user may also un-group them again if desired. The grouping is made with the use of different color marks 1901(1 and 2) next to the name of the currency pair 1903(1 and 2) traded. GUI mockup example 1900 shows how this is possible in a Graphical User Interface. The user selects a unique color 1901(1) to denote one group, another color for another group etc. By simply changing the color, the specific pair moves to the group marked by the same color. The purpose of making groups is to get calculated combined results per group, for example pips and money earnings and losses and automating trades position closing per group when pre-defined “take profit” or “stop loss” values are met.

Referring now to FIG. 19, there is illustrated an example of a GUI that shows the opened trades and the individual groups formed by using different color marks 1901(1)-(3). GUI 2000 is similar to GUI 1900 but it is designed for more than 2 currency pairs. Instead filling into a “gap” field, the user can edit the pairs value fields manually and automate the correlated pairs trading process the same way as in operation 1810. By simply changing the color of a trade, the user can move the trades into different groups as in operation 1810, for the same purpose.

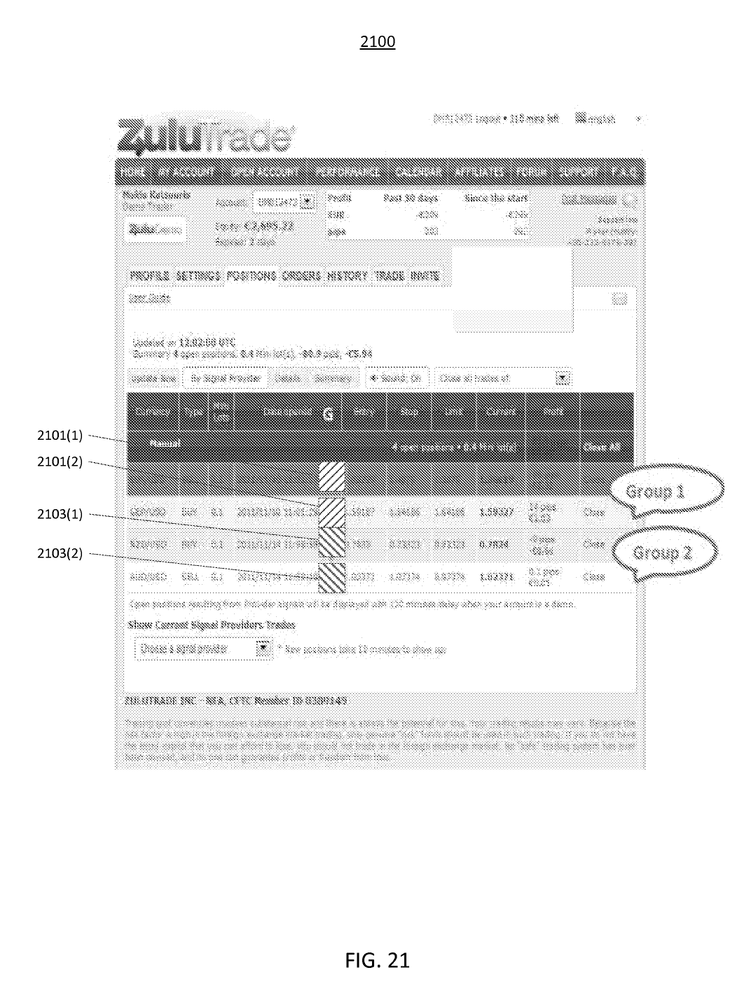

Referring now to FIG. 21, there is illustrated an example of a GUI that shows the opened trades and the individual groups formed by using different color marks 2101 and 2103. The user may change the color mark 2101 and 2103 for every open trade and by doing so the trade is automatically being moved to another group (Group 1 and Group 2) which is denoted by the new color. The per-color groups have their combined profits and losses calculated by the platform application and can be opened/closed together or automatically closed when user-set limits are met as prior defined by using the GUI elements.

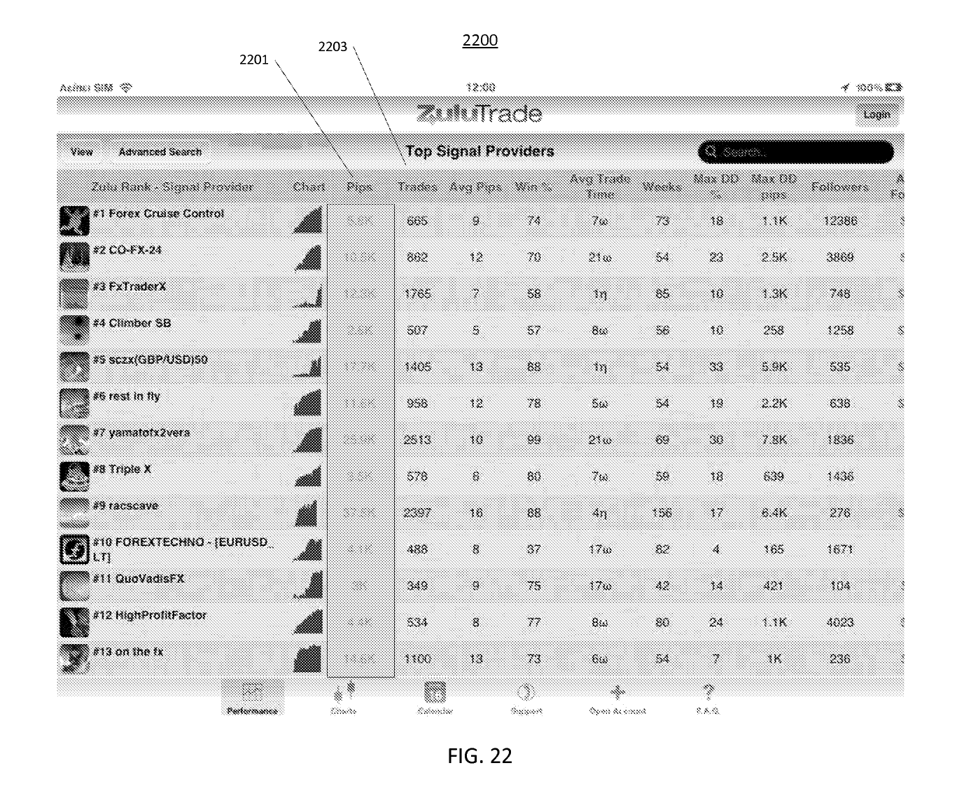

FIG. 22 illustrates a graphical user interface 2200 displaying a set of signal providers in table format, where column 2201 is the pips per signal provider and column 2203 is the trades per signal provider. The column 2201 is selected to be highlighted by the user 101.

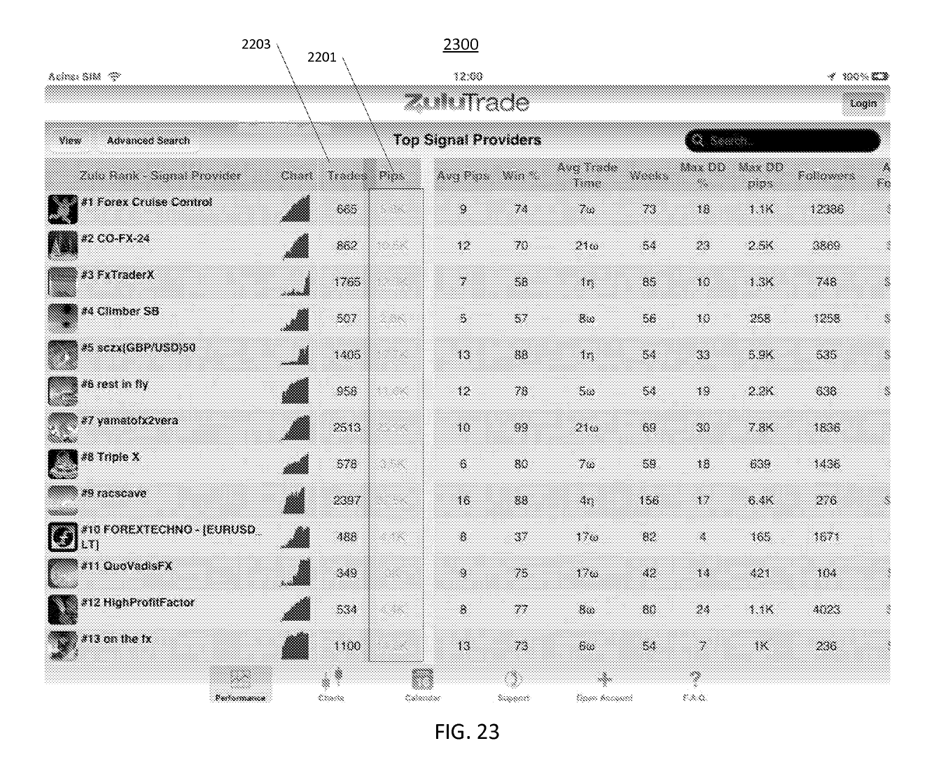

FIG. 23 illustrates a graphical user interface 2300 displaying a set of signal providers in table format, where column 2201 is the pips per signal provider and column 2203 is the trades per signal provider. The column 2201 is highlighted and moved by the user 101 into a new position relative to column 2203.

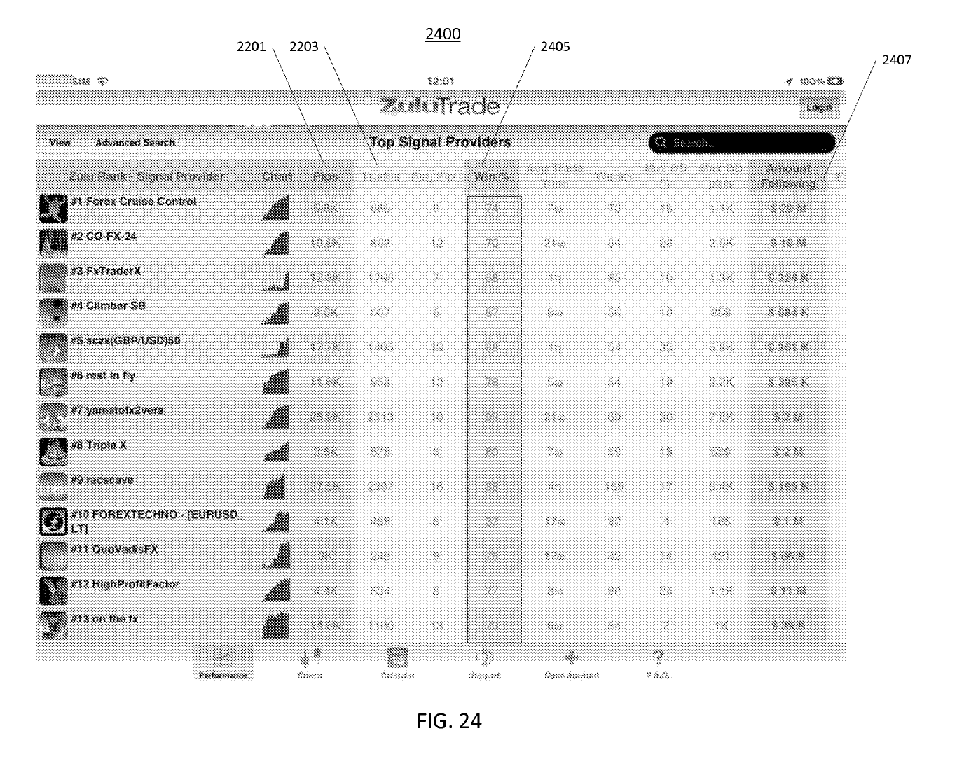

FIG. 24 is a graphic illustrating the “win%” column 2405 in focus mode (high-contrasted). The graphic user interface 2400 displays a set of signal providers in table format, where column 2201 is the pips per signal provider and column 2203 is the trades per signal provider. The “win%” column 2405 in focus mode displays a winning percentage per signal provider and the “Amount Following” column 2407 is also changed in contrast.

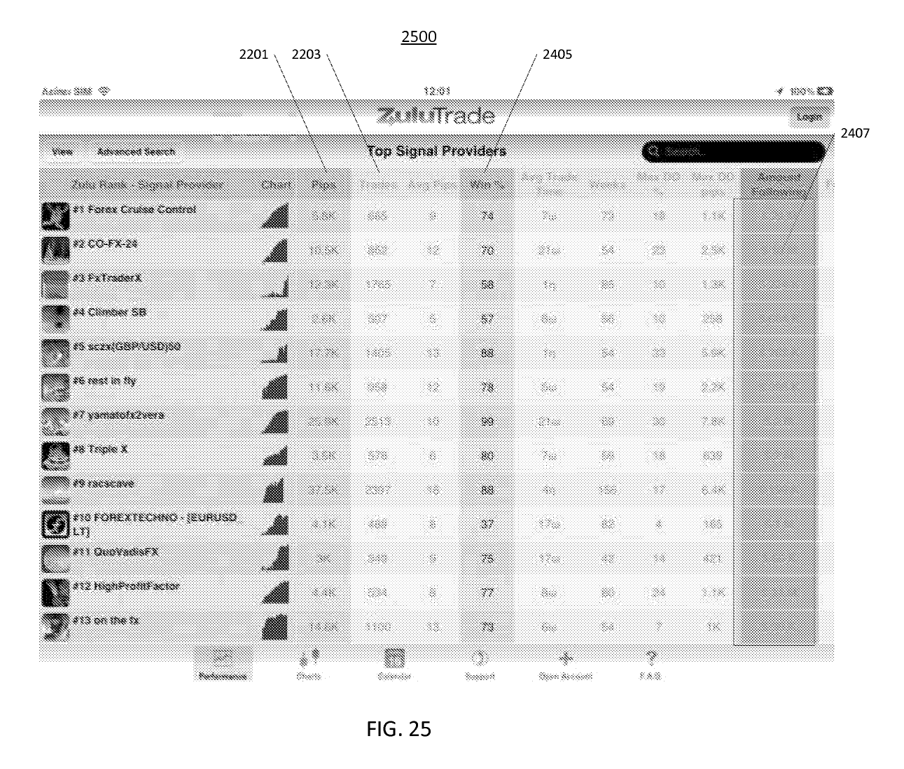

FIG. 25 is a graphic illustrating the “Amount Following” column 2407 emphasized by changing column's background color. The graphic user interface 2500 displays a set of signal providers in table format, where column 2201 is the pips per signal provider and column 2203 is the trades per signal provider. The “Amount Following” column 2407 emphasized by changing column's background color indicated by the outline.

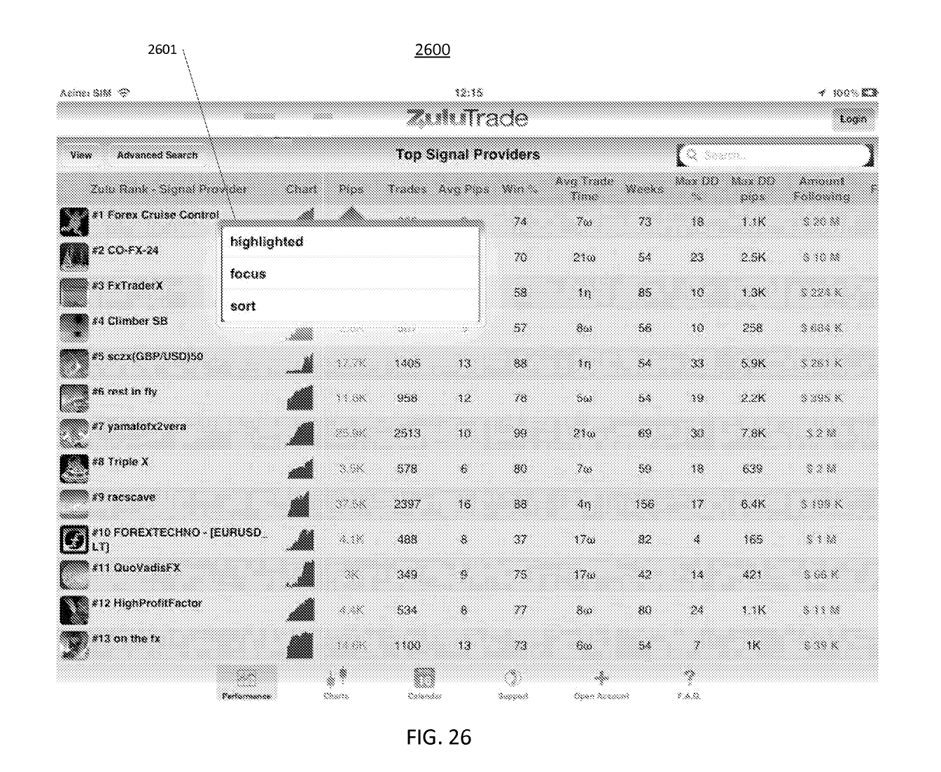

FIG. 26 is a graphic illustrating the prompt the user can activate and choose between “highlight”, “focus” and “sort” selections 2601 for every table column of the graphic user interface 2600 displaying a set of signal providers in table format.

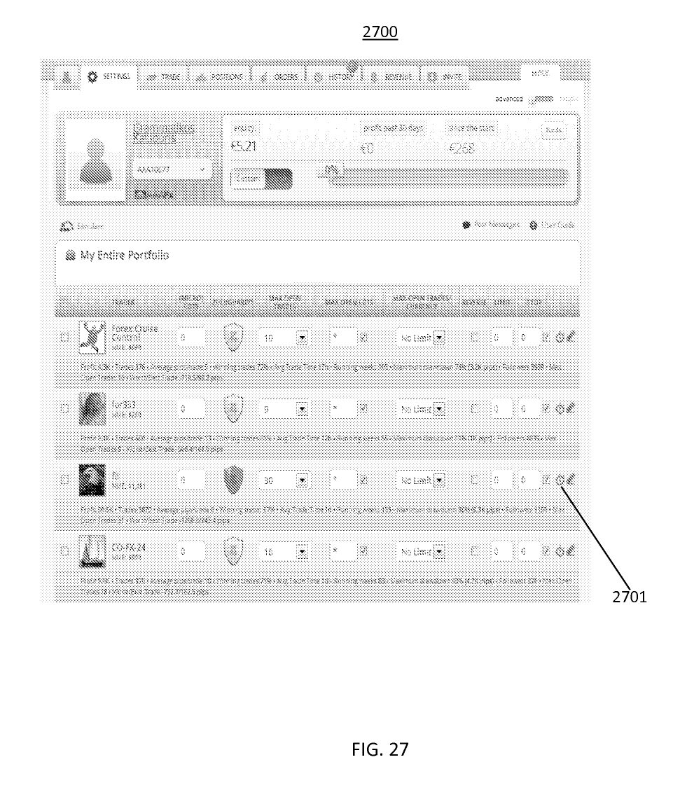

FIG. 27 illustrates a graphical user interface 2700 displaying the time filter selection 2701 the user can use and set hour zones during it is not desired to make any new position openings.

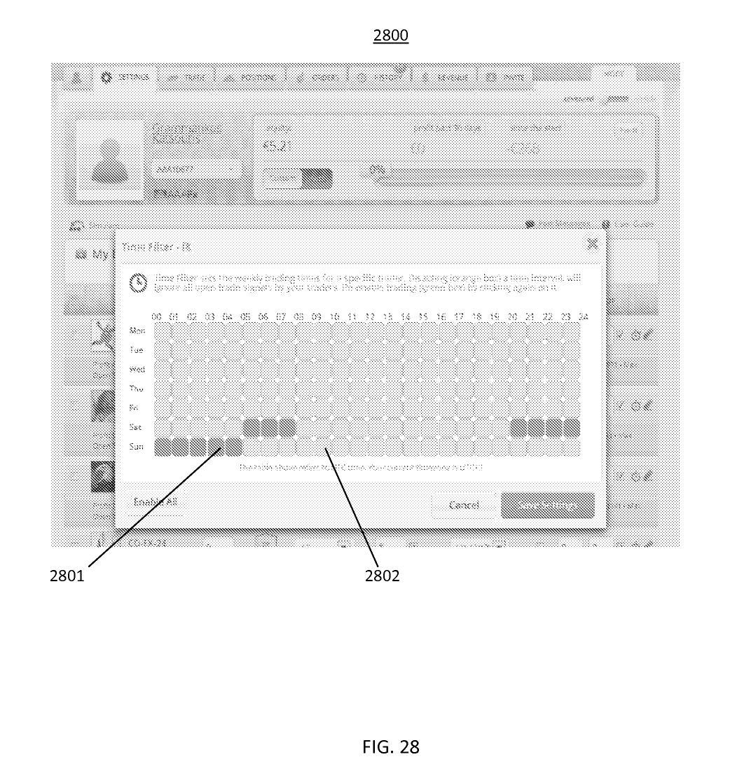

FIG. 28 illustrates a graphical user interface 2800 displaying the time filter function. The user can set the weekly trading hours for the selected signal provider. Disabling (orange box 2801) a time interval, will ignore all open trade signals by the signal provider. Re-enable trading (green box 2802) is done by clicking again on the box. With this new addition, the user can select weekly trading hours for every signal provider who is selected. Using this function the user can control new trading placements over hours or days on a week-based schedule.

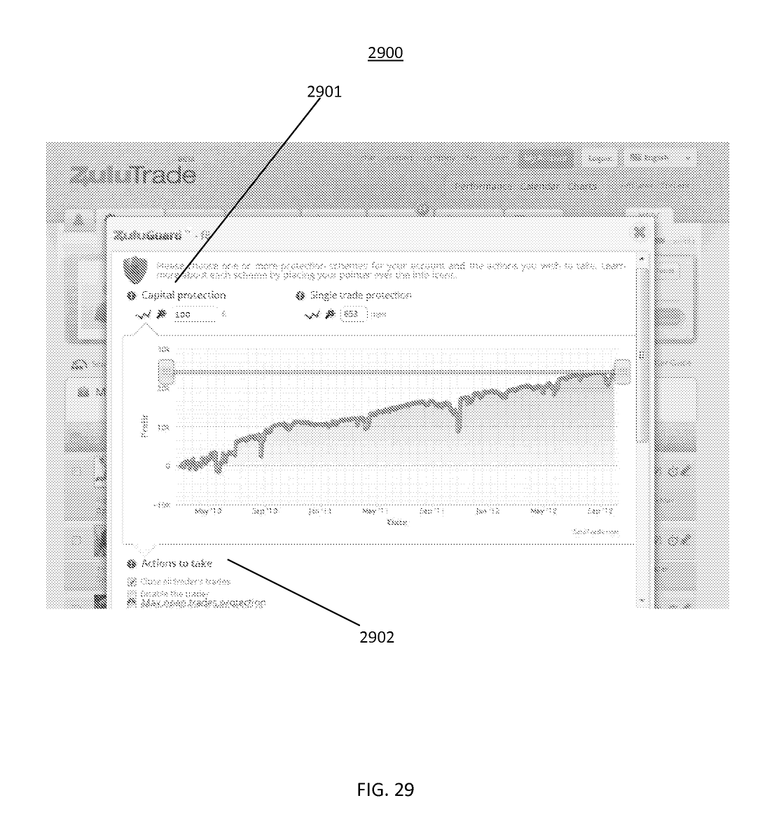

FIG. 29 is a graphic illustrating the Zuluguard™ protection scheme 2900 for capital amount 2901 and actions to be taken 2902 if the signal provider actions make a loss of capital more than the specified amount (2901). It also illustrates the profits of the selected trader over time 2903 and the threshold bar 2904 the user can place and adjust the threshold value.

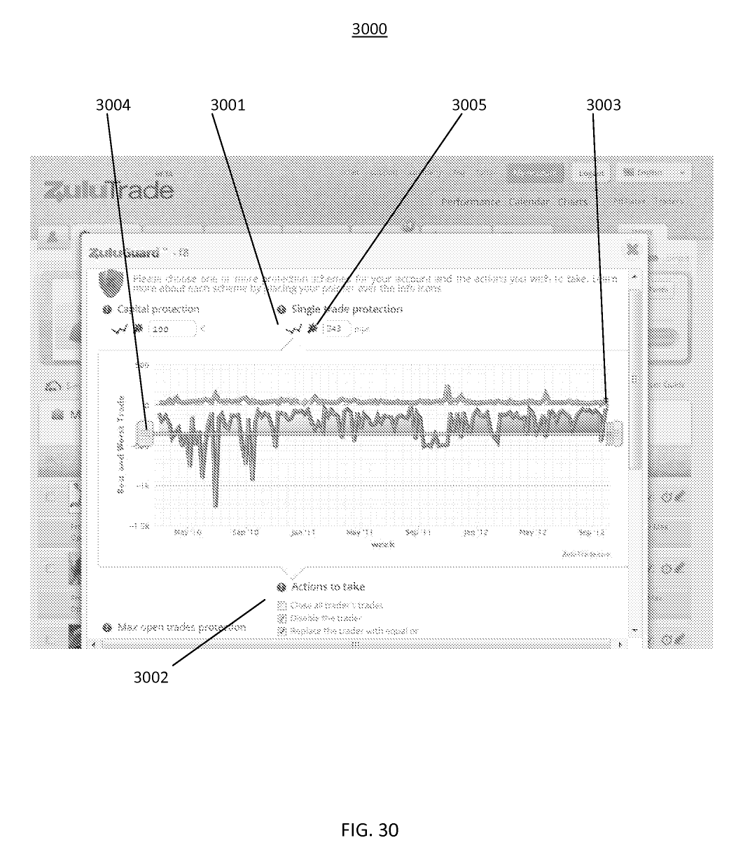

FIG. 30 is a graphic illustrating the Zuluguard™ protection scheme 3000 for single trade protection in pips 3001 and actions to be taken 3002 if the signal provider actions make a loss in pips greater than the specified amount 3001. It also illustrates the best and worst trade made by the selected trader over time 3003 and the threshold bar 3004 the user can place and adjust the threshold value. A website system automatic suggestion of where to place the threshold is provided 3005 and is based on the mean value of a number of latest larger drawdowns in placements the signal provider had in the past. Zuluguard™ is a protection scheme, a great step into the field of the advancement of automated trading. The Zuluguard™ scheme offers capital protection or single trade protection, user defined or website proposed, alterable from the user. The user (follower) can manually activate this scheme per signal provider and automate more actions to be taken when this signal provider reach a threshold setting of drawdown in pips. The unique visualization of the signal provider's performance over time allows for easy setting of the threshold value because the user can readily look at the signal provider's past performance and his frequent fluctuations of profits and losses over time, Setting a threshold value close to those fluctuations can offer significant protection by automating “actions to take” like closing all trader's open trades, disabling this trader, or replacing this trader with another equal or better trader, as they are ranked in the web-site system database. This greatly promotes the method of automated trading by following signal providers, not found in the past. The user can also set a value for the maximum allowable number of open trades for the selected signal provider.

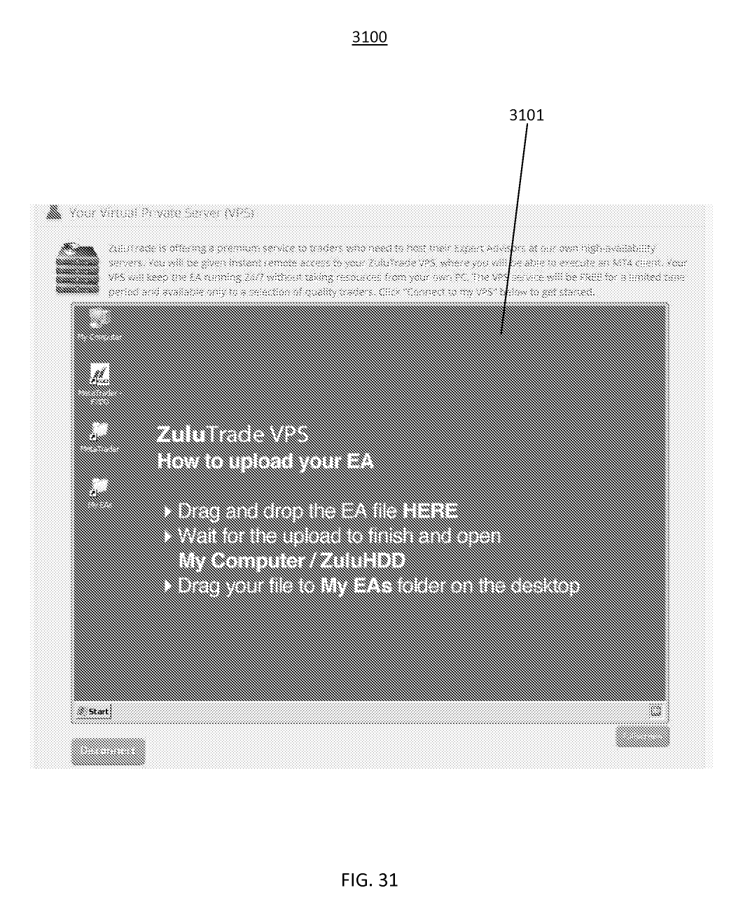

FIG. 31 is a graphic illustrating the Virtual Personal Server (VPS) function of the website. It is actually a virtual computer and storage space provided for the users of the website (signal providers) embedded into the website in order to free resources from their own home computers that is usually needed to operate in a long-hour basis for their Expert Advisors (EAs) needs.

As described above, the inventor has discovered an interactive control implemented using software e.g., HTML and web pages, of a website-based trading platform application for automating the allocation of a user's trading lots on following the trading actions of one or more signal providers, in correlation with a user-settable maximum risk graded value. The user first selects one or more signal providers he chooses to follow (i.e., to rely on for advice) from a list provided by the platform and then adjusts a sliding bar 113, or other similar object of a Graphical User Interface, to set the amount of the maximum investment risk the user is willing to undertake. When a signal provider is recommending profitable trades, then more and more users would add him in their portfolio (select him among others) and can activate him whenever they want to execute trades the way he does i.e., which currency pair, when to buy, when to sell.

The system then automatically scales the user's lots per provider by allocating the number of lots, which will be traded per signal provider, per trade, by evaluating the worst historical data (drawdown performance over period of a year or other long time) of each signal provider in the way that if the signal provider will display his historically worst performance again, the amount of money that would be lost from the users account will not exceed the user's risk value as set with the sliding bar.

By using this interactive control, the user who chooses the strategy of following historically-good performers (i.e. trade in the same transactions as they will do) by automatically scaling his/her own lots and allocate them on those selected and activated signal providers in correlation with a user-defined risk factor, performs a very complex and time consuming procedure which is now easily and interactively feasible in no significant amount of time.

In addition, a non experienced user, accepting his/her own maximum investment risk, by self setting it from the graphical user interface object, is now able to automatically execute, by letting the trading platform application doing it for behalf of him/her, really professional transactions by simply selecting to following one or more professional signal providers.

The platform is able to offer protection of the user's accounts, of the users who choose this strategy, up to the limit of each user's risk as set onto the interactive control.

It would be understood that the instant invention is a computer based and that the steps for trading currency or rendering a graphical user interface to receive input aiding in treading currency are performed by a microprocessor executing a program stored on a computer readable recording medium.

Additional objects, advantages, and novel features of the present invention will become apparent to one ordinarily skilled in the art upon examination of the attached appendixes, which are not intended to be limiting.

The appendixes are an inseparable part of the specification of this application.

Although the preceding text sets forth a detailed description of one or more different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

Examples of various features/aspects/components/operations have been provided to facilitate understanding of the disclosed embodiments of the present invention. In addition, various preferences have been discussed to facilitate understanding of the disclosed embodiments of the present invention. It is to be understood that all examples and preferences disclosed herein are intended to be non-limiting.

Although selected embodiments of the present invention have been shown and described individually, it is to be understood that at least aspects of the described embodiments may be variously combined.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. An automated trading method, comprising:
receiving, via a first graphical user interface rendered by a programmed computer, a selected set of signal providers from a set of signal providers on a second graphical user interface of a trading platform and displaying the set of selected signal providers;
receiving, via the first graphical user interface rendered by the programmed computer, a user defined risk via a sliding bar displayed on the first graphical user interface, the sliding bar having a user-movable portion that expresses a selectable percentage value of risk;
allocating, via the programmed computer, a lot value for each selected signal provider of the set of selected signal providers and displaying the allocated lot value for each signal provider next to an identification of each signal provider of the set of selected signal providers on the first graphical user interface;
correlating, via the programmed computer, a risk value for each selected signal provider with trading signals from each selected signal provider; and
opening and closing trades, via the programmed computer, of an investment amount based on the trading signals for each selected signal provider, the investment amount based on the lot value and the risk value for each selected signal provider.

2. The method of claim 1, wherein allocating the lot value for each selected signal provider of the set of selected signal providers includes:
calculating the risk value for each signal provider of the of one or more selected signal providers;
calculating a worst case lots value;
calculating a hypothetical profit target; and
calculating a number of lots for each signal provider of one or more specified signal providers.

3. The method of claim 2, wherein calculating the worst case lots value includes:
dividing the risk for each provider of the set of providers by a product of a maximum drawdown of each signal provider and a dollar value of the user's currency.

4. The method of claim 3, wherein calculating the hypothetical target includes:
multiplying the worst case lots value by a profit of a worst signal provider of the one or more specified signal providers and the dollar value of the user's currency.

5. The method of claim 4, wherein calculating the number of lots for each signal provider of the one or more specified signal providers includes:
dividing the hypothetical profit target by the product of a smallest price change that a given exchange rate makes for each signal provider of the one or more specified signal providers and the dollar value of the user's currency

6. The method of claim 1, wherein allocating the lot value for each selected signal provider of the set of selected signal providers includes:
calculating an available capital of the user to invest;
calculating a necessary minimum equity of each signal provider of the one or more specified signal providers;
calculating an allocated number of lots of each signal provider of the one or more specified signal providers; and
calculating an adjustment to the allocated number of lots upon receiving input of the user varying weight factors.

7. The method of claim 6, wherein calculating the available capital of the user to invest includes:
multiplying the user's account balance by the user defined risk.

8. The method of claim 7, wherein calculating the necessary minimum equity of each signal provider of the one or more specified signal providers includes:
summing a max provider drawdown in pips for each signal provider with a product of a maximum open trades of each signal provider and 10.

9. The method of claim 8, wherein calculating allocated number of lots of each signal provider of the one or more specified signal providers includes:
dividing the capital available by the necessary minimum equity of each signal provider.

10. The method of claim 9, wherein calculating the adjustment to the allocated number of lots upon receiving input of the user varying weight factors includes:
multiplying a quotient of the capital available by the necessary minimum equity of each signal provider and a quotient of weight factors for each signal provider varied by the user and a total weight of all the weight factors for each signal provider.

11. The method of claim 1, further comprising:
displaying via the second graphical user interface the set of signal providers and metrics associated with signal providers as a table;
receiving input via the second graphical user interface at least one of an instruction to (1) change a background color of one of an entire column and row; (2) change a contrast intensity of one of the entire column and row; (3) change the order of appearance of the table by sorting the data from a user selected column; (4) change the position of one of the column and row;
redisplaying the table in response to the received the at least one of an instruction.

12. The method of claim 1, further comprising:
receiving a message relevant to a foreign currency pair selling or buying trade from a selected signal provider of the set of selected signal providers, the message associated with a foreign currency pair selling or buying trade;
transmitting a special notification to every user having an opened trade on the specific currency pair originated from the selected signal provider;
receiving, via a third graphical user interface, a selection to read the message;
transmitting the signal provider's message;
transmitting additional comments left by other users, if any;
accepting the user's possible new comment; and
transmitting the user's new comment to the web server.

13. An automated trading method, comprising:
receiving, via a graphical user interface rendered by a programmed computer, a selection of two or more foreign currency pairs displayed on the graphical user interface;
receiving, via the graphical user interface rendered by the programmed computer, one of (1) a selected gap value in pips and (2) a specified value for each currency pair of the selection of two or more foreign currency pairs to trigger an automatic position opening;
receiving, via the graphical user interface rendered by the programmed computer, a selected lot number of selling the higher value pair of the selection of two or more foreign currency pairs;
receiving, via the graphical user interface rendered by the programmed computer, one of (1) a selected lot number of buying the lower value pair of the selection of two or more foreign currency pairs and (2) a specified lot number for each currency pair of the selection of two or more foreign currency pairs;
receiving, via the graphical user interface rendered by the programmed computer, a selected maximum combined loss closing value;
receiving, via the graphical user interface rendered by the programmed computer, a selected maximum combined profit closing value;
calculating, via the programmed computer, one of (1) a combined loss and (2) a profit value using current forex values of the selection of two or more foreign currency pairs;
grouping, via the graphical user interface rendered by the programmed computer, pairs of the selection of two or more foreign currency pairs by using color marks to display combined profit and loss of the grouped pairs;
closing, via the programmed computer, positions for the grouped currency pairs upon a profit target being met, or when loss limit has been met.

14. A non-transitory computer readable recording medium with a computer program recorded thereon, the computer program executed by a process to perform the method of automated trading, comprising:
receiving, via a first graphical user interface, a selected set of signal providers from a set of signal providers on a second graphical user interface of a trading platform and displaying the set of selected signal providers;
receiving, via the first graphical user interface, a user defined risk via a sliding bar displayed on the first graphical user interface, the sliding bar having a user-movable portion that expresses a selectable percentage value of risk;
allocating a lot value for each selected signal provider of the set of selected signal providers and displaying the allocated lot value for each signal provider next to an identification of each signal provider of the set of selected signal providers on the first graphical user interface;
correlating a risk value for each selected signal provider with trade signals from each selected signal provider; and
opening and closing trades of an investment amount based on the trading signals for each selected signal provider, the investment amount based on the lot value and the risk value for each selected signal provider.

15. The non-transitory computer readable recording medium of claim 14, wherein allocating the lot value for each selected signal provider of the set of selected signal providers includes:
calculating the risk value for each signal provider of the of one or more selected signal providers;
calculating a worst case lots value;
calculating a hypothetical profit target; and
calculating a number of lots for each signal provider of one or more specified signal providers.

16. The non-transitory computer readable recording medium of claim 14, wherein allocating the lot value for each selected signal provider of the set of selected signal providers includes:
calculating an available capital of the user to invest;
calculating a necessary minimum equity of each signal provider of the one or more specified signal providers;
calculating an allocated number of lots of each signal provider of the one or more specified signal providers; and
calculating an adjustment to the allocated number of lots upon receiving input of the user varying weight factors.

17. The non-transitory computer readable recording medium of claim 14, further comprising:
receiving a message relevant to a foreign currency pair selling or buying trade from a selected signal provider of the set of selected signal providers, the message associated with a foreign currency pair selling or buying trade;
transmitting a special notification to every user having an opened trade on the specific currency pair originated from the selected signal provider;
receiving, via a third graphical user interface, a selection to read the message;
transmitting the signal provider's message;
transmitting additional comments left by other users, if any;
accepting the user's possible new comment; and
transmitting the user's new comment to the web server.
